(19) United States
(12) Patent Application Publication
(10) Pub. No.: US 2024/0346687 A1
(43) Pub. Date: Oct. 17, 2024

(54) MEASURING SYSTEM

(71) Applicant: DAI NIPPON PRINTING CO., LTD., Tokyo (JP)

(72) Inventors: Keiji KASHIMA, Tokyo (JP); Tadashi FURUKAWA, Tokyo (JP); Koujiro OOKAWA, Tokyo (JP); Yukio TANIGUCHI, Tokyo (JP); Hideaki FUJISAKI, Tokyo (JP)

(73) Assignee: DAI NIPPON PRINTING CO., LTD., Tokyo (JP)

(21) Appl. No.: 18/681,342

(22) PCT Filed: Jul. 19, 2022
(86) PCT No.: PCT/JP2022/028106

§ 371 Date: Feb. 5, 2024

(30) Foreign Application Priority Data
Aug. 5, 2021 (JP) 2021-128862
Mar. 31, 2022 (JP) 2022-058637

(51) Int. Cl. G06T 7/73; G06T 7/60; G06V 10/70

(52) U.S. Cl. CPC G06T 7/74; G06T 7/60; G06V 10/70; G06T 2207/10024; G06T 2207/30108; G06T 2207/30204

(57) ABSTRACT

A measuring system with which it is easy to manufacture a marker, and which is capable of high precision measurement. A marker to be measured by a measuring system is provided with a base material layer, a first layer which is laminated onto one surface of the base material layer and which is observed in a first color, and a second layer which is partially laminated onto the first layer, is observed in a second color different from the first color, and partially conceals the first layer, wherein the first layer is observable in a region in which the second layer is not laminated, and the second layer is formed by means of a resist material.

### TECHNICAL FIELD

The present invention relates to a measuring system.

### BACKGROUND ART

Markers are attached to targets so as to enable various automatic control devices to recognize the targets, thereby performing highly accurate automatic control. Such markers are used, for example, for the control of robots at production sites and for space missions. As examples of such markers, markers printed on paper have been conventionally and widely used because they are easy to produce. However, with such simple markers, the boundary line of a mark is unclear, and the size of the mark and the spacing between multiple marks change due to the expansion and contraction of paper, so that sufficient accuracy cannot be ensured when highly accurate control is required.

Therefore, as a technique for achieving a highly accurate marker, Patent Document 1 discloses a technique for making holes in a metal plate by cutting work and filling the holes with resin to form a marker. However, according to the technique of Patent Document 1, it takes a lot of time and labor to manufacture markers because it is necessary to enhance the accuracy of machining, and also there is a limit to enhancing the accuracy.

### CITATION LIST

### Patent Document

Patent Document 1: Japanese Unexamined Patent Application, Publication No. H5-312521

### DISCLOSURE OF THE INVENTION

### Problems to be Solved by the Invention

It is an object of the present invention to provide a measuring system with which it is easy to manufacture a marker, and which is capable of high precision measurement.

### Means for Solving the Problems

The present invention solves the above-mentioned problems by the following solving means. In order to facilitate understanding, the description will be given with reference signs corresponding to the embodiments of the present invention, but the present invention is not limited thereto.

A first aspect of the present invention is directed to a measuring system (500), including: a marker (1, 1B, 1C); an imager (201) that photographs the marker; and a calculator (202) that calculates at least one selected from a relative positional relationship between the imager and the marker (1, 1B, 1C), a dimension of an object or a distance between designated positions in a vicinity of the marker (1, 1B, 1C), a distance between a plurality of markers (1, 1B, 1C) arranged, and a posture of the marker (1, 1B, 1C), using an image of the marker (1, 1B, 1C) photographed by the imager (201); the marker (1, 1B, 1C) including: a base material layer (10); a first layer (20, 20C) that is laminated on an observation side of the base material layer (10) and observed in a first color; and a second layer (30, 30C) that is partially laminated on an observation side of the first layer (20, 20C) and observed in a second color different from the first color, the second layer (30, 30C) partially concealing the first layer (20, 20C), wherein the first layer (20, 20C) is observable in a region where the second layer (30, 30C) is not laminated, and the second layer (30, 30C) includes a resist material.

A second aspect of the present invention is an embodiment of the measuring system (500) according to the first aspect. In the measuring system (500), the first layer (20, 20C) includes a resist material.

A third aspect of the present invention is directed to a measuring system (500), including: a marker (1, 1B, 1C); an imager (201) that photographs the marker (1, 1B, 1C); and a calculator (202) that calculates at least one selected from a relative positional relationship between the imager (201) and the marker (1, 1B, 1C), a dimension of an object or a distance between designated positions in a vicinity of the marker (1, 1B, 1C), a distance between a plurality of markers (1, 1B, 1C) arranged, and a posture of the marker (1, 1B, 1C), using an image of the marker (1, 1B, 1C) photographed by the imager (201); the marker (1, 1B, 1C) including: a base material layer (10); a first layer (20, 20C) that is laminated on an observation side and an entire surface of the base material layer (10) and observed in a first color; and a second layer (30, 30C) that is partially laminated on an observation side of the first layer (20, 20C) and observed in a second color different from the first color, the second layer (30, 30C) partially concealing the first layer (20, 20C), wherein the first layer (20, 20C) is observable in a region where the second layer (30, 30C) is not laminated, and the base material layer (10) has a linear expansion coefficient of 10×10⁻⁶/° C. or less.

A fourth aspect of the present invention is an embodiment of the measuring system (500) according to any one of the first to third aspects. In the measuring system (500), the base material layer (10) includes glass.

A fifth aspect of the present invention is an embodiment of the measuring system (500) according to any one of the first to fourth aspects. In the measuring system (500), either the first layer (20, 20C) or the second layer (30, 30C) is observable as a mark (2) having an independent shape, and the mark (2) includes three or more marks (2) which are arranged to be spaced from one another.

A sixth aspect of the present invention is an embodiment of the measuring system (500) according to the fifth aspect. In the measuring system (500), a figure (5) for identification is arranged, and the calculator (202) identifies the marker (1, 1B, 1C) with reference to the figure (5).

A seventh aspect of the present invention is an embodiment of the measuring system (500) according to the sixth aspect. In the measuring system (500), the calculator (202) performs: a first calculation process of calculating at least one selected from a relative positional relationship between the imager (201, 450) and the marker (1), a dimension of an object or a distance between designated positions in a vicinity of the marker (1), a distance between a plurality of markers (1) arranged, and a posture of the marker (1), based on images of the marks (2) included in the image of the marker (1); and a second calculation process of calculating at least one selected from a relative positional relationship between the imager (201, 450) and the marker (1), a dimension of an object or a distance between designated positions in a vicinity of the marker (1), a distance between a plurality of markers (1) arranged, and a posture of the marker, based on an image of the figure (5) for identification included in the image of the marker (1).

An eighth aspect of the present invention is an embodiment of the measuring system (500) according to the seventh aspect. In the measuring system (500), the calculator (202) outputs a calculation result by the first calculation process if calculation is performable properly by the first calculation process, and outputs a calculation result by the second calculation process if calculation is not performable properly by the first calculation process.

A ninth aspect of the present invention is an embodiment of the measuring system (500) according to the eighth aspect. In the measuring system (500), the calculator (202) performs the first calculation process and the second calculation process in parallel.

A tenth aspect of the present invention is an embodiment of the measuring system (500) according to any one of the first to third aspects. The measuring system (500) further includes a controller (203) that performs control based on a calculation result of the calculator (202).

An eleventh aspect of the present invention is directed to a measuring method of the measuring system (500) according to any one of the first to third aspects, the method including: a step of the imager (201) photographing the marker (1, 1B, 1C); and a step of the calculator (202) calculating at least one selected from a relative positional relationship between the imager (201) and the marker (1, 1B, 1C), a dimension of an object or a distance between designated positions in a vicinity of the marker (1, 1B, 1C), a distance between a plurality of markers (1, 1B, 1C) arranged, and a posture of the marker (1, 1B, 1C), using an image of the marker (1, 1B, 1C) photographed by the imager (201).

A twelfth aspect of the present invention is directed to a program of the measuring system (500) according to any one of the first to third aspects. The program causes a computer (202, 203) to execute: a step of the imager (201) photographing the marker (1, 1B, 1C); and a step of the calculator (202) calculating at least one selected from a relative positional relationship between the imager (201) and the marker (1, 1B, 1C), a dimension of an object or a distance between designated positions in a vicinity of the marker (1, 1B, 1C), a distance between a plurality of markers (1, 1B, 1C) arranged, and a posture of the marker (1, 1B, 1C), using an image of the marker (1, 1B, 1C) photographed by the imager (201).

### Effects of the Invention

The present invention provides the marker that is easy to manufacture and has high accuracy. The present invention provides the marker that is capable of displaying moire brightly. The present invention provides a marker that is easy to recognize even under an environment where sunlight, illumination light, or the like hits the marker.

### BRIEF DESCRIPTION OF THE DRAWINGS

FIG. 1 is a diagram showing a marker 1 of a first embodiment;

FIG. 2 is a cross-sectional view of the marker which is cut at the position of arrows A-A in FIG. 1;

FIG. 3A to FIG. 3F are diagrams showing a manufacturing process of the marker 1;

FIG. 4A and FIG. 4B are partially enlarged views showing results obtained by photographing the marks 2 of the present embodiment and a comparative example;

FIG. 5 is a diagram showing the change in light intensity with respect to the change in position at the boundary between black of a first layer 20 and white of a second layer 30;

FIG. 6 is a diagram showing a marker 1B of a second embodiment;

FIG. 7 is a diagram showing a marker 1C of a third embodiment;

FIG. 8 is a cross-sectional view of the marker which is cut at the position of arrows B-B in FIG. 7;

FIG. 9A to FIG. 9F are diagrams showing a manufacturing process of the marker 1C in which the front and back (the top and bottom) are reversed with respect to that of FIG. 8;

FIG. 10 is a diagram showing a marker multi-imposition body 100;

FIG. 11 is a diagram showing a form in which an electrode layer 95 is provided;

FIG. 12 is a diagram showing a modified form in which a first layer 20 is set to white and a second layer 30 is set to black in the first embodiment;

FIG. 13 is a diagram showing a modified form in which the first layer 20 is set to white and the second layer 30 is set to black in the first embodiment;

FIG. 14 is a diagram showing a modified form in which a first layer 20C is set to black and a second layer 30C is set to white in the third embodiment;

FIG. 15 is a diagram showing a modified form in which the first layer 20C is set to black and the second layer 30C is set to white in the third embodiment;

FIG. 16 is a cross-sectional view showing a modified form in which a flattening layer 91 is provided in an opening portion 30a of the second layer 30 in the first embodiment;

FIG. 17 is a diagram showing a fourth embodiment of the marker according to the present invention;

FIG. 18 is a cross-sectional view of the marker which is cut at the position of arrows A-A in FIG. 17;

FIG. 19A to FIG. 19C are enlarged views of the vicinity of a second pattern 43 in order to explain a cause of occurrence of unnecessary moire;

FIG. 20 is a diagram illustrating details of a first pattern 23 and the second pattern 43;

FIG. 21 is a diagram showing a state of the marker 1 when the marker 1 is viewed in a diagonal direction;

FIG. 22 is a diagram showing a fifth embodiment of the marker according to the present invention;

FIG. 23 is a cross-sectional view of the marker which is cut at the position of arrows A-A in FIG. 22;

FIG. 24 is a graph showing an effect of a light diffusion layer 80;

FIG. 25 is a diagram showing a state of the marker 1 when the marker 1 is viewed in a diagonal direction;

FIG. 26 is a diagram showing a modified form in which the colors of the first layer 20 and the second layer 30 are exchanged by each other;

FIG. 27 is a diagram showing a sixth embodiment of a marker according to the present invention; and

FIG. 28 is a diagram showing a pallet P to which the marker 1 of the sixth embodiment is attached.

FIG. 29 is a diagram showing a measuring system 500 that includes the marker 1 of the sixth embodiment;

FIG. 30 is a flowchart showing the flow of control operation of a forklift 200 that uses the measuring system 500 of the present embodiment;

FIG. 31 is a diagram showing a seventh embodiment of a marker according to the present invention;

FIG. 32 is a diagram showing a marker multi-imposition body 100 of a seventh embodiment;

FIG. 33 is a diagram showing a pallet P to which the marker 1 of the seventh embodiment is attached.

FIG. 34 is a diagram showing a measuring system 500 that includes the marker 1 of the seventh embodiment;

FIG. 35 is a flowchart showing the flow of control operation of the forklift 200 that uses the measuring system 500 of the present embodiment;

FIG. 36 is a diagram showing a state in which part of the mark 2 is not properly photographed due to an obstacle;

FIG. 37 is a diagram showing a first modified form of a utilization form of the marker 1 of the seventh embodiment; and

FIG. 38 is a diagram showing a second modified form of a utilization form of the marker 1 of the seventh embodiment.

### PREFERRED MODE FOR CARRYING OUT THE INVENTION

Best modes for carrying out the present invention will be described with reference to the drawings and the like. In the measuring system according to the present invention, by photographing the marker with the camera, the relative positional relationship and the like between the marker and the camera is accurately measured. Accordingly, the form of the marker is important. Therefore, first, examples of specific forms of the markers are described in the following first to sixth embodiments, and a measuring system that includes the marker 1 in the sixth embodiment is further described.

### First Embodiment

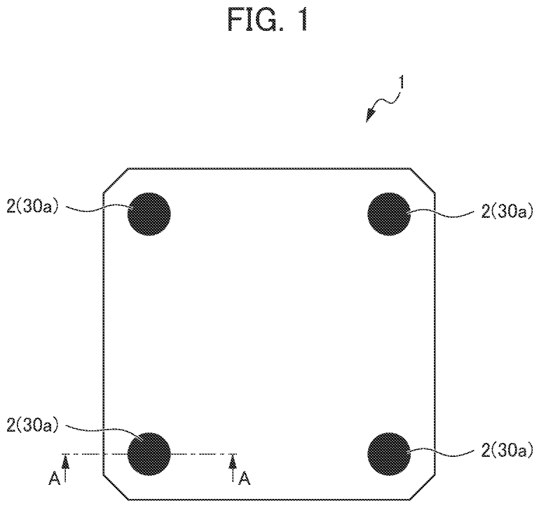

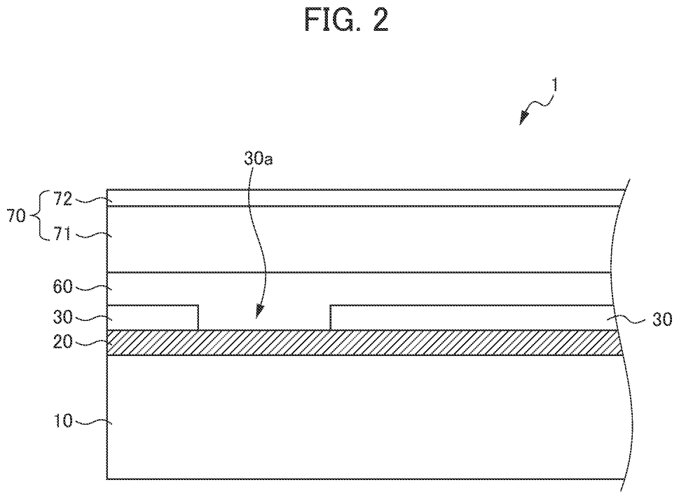

FIG. 1 is a diagram showing a marker 1 of a first embodiment. FIG. 2 is a cross-sectional view of a marker which is cut at the position of arrows A-A in FIG. 1. The following figures including FIG. 1 and FIG. 2 are schematic diagrams, and the sizes and shapes of respective parts are presented by being exaggerated or omitted on an as-needed basis to facilitate understanding thereof. Further, the following description will be made while presenting specific numerical values, shapes, materials, and the like, but these may be changed as appropriate. In the present specification, terms such as plate, sheet, and film are used. The terms of plate, sheet, and film are generally used in the decreasing order of thickness, and these terms are also used in the same way in the present specification. However, such a manner of use has no technical meaning, and thus these terms may be replaced as appropriate. Further, in the present invention, a “transparent” substance means a substance which transmits therethrough light having at least a wavelength to be used. For example, if a substance transmits infrared rays although it does not transmit visible light, the substance shall be treated as a transparent substance when used for applications using infrared rays. It should be noted that specific numerical values specified in the present specification and the claims should be treated as including a general error range. In other words, a difference of about ±10% is substantially the same, and a value set in a range slightly beyond the numerical range of the present invention should be interpreted as being substantially within the numerical range of the present invention.

As shown in FIG. 1, a marker 1 is configured like a plate having a substantially square shape when viewed from the normal direction of a surface on which a protective layer 70 described later is provided, and includes a plurality of marks 2 arranged thereon. In the present embodiment, the marker 1 is formed so that the shape thereof when viewed from the surface side is a substantially square shape of 60 mm×60 mm (a shape chamfered at each corner portion), and each of totally four circular marks 2 is provided near each of the four corners of the marker 1 so that the circular marks are arranged to be spaced from one another at intervals. It is desirable that at least three marks 2 are arranged. This is because, for example, if the positions of the centers of gravity of the marks 2 are calculated at three points from an observation result of the marks 2, the relative position, inclination, and posture between the observation position (camera or the like) and the marker 1 can be accurately detected. Further, if the number of marks 2 is larger than 3, for example, when some marks 2 are unclearly observed due to some kind of obstacle, the position detection can be performed from an observation result of the remaining marks 2. By using a plurality of marks 2, the accuracy of position detection can be improved.

The marker 1 is attached to, for example, a side surface of a measurement target such as a pallet on which luggage is placed, and can be used for automatic driving control of an automatic driving forklift or the like which has a camera. In other words, the relative positional relationship between the forklift and the pallet can be accurately grasped from a result photographed by the camera, and the operation of the forklift can be controlled based on the relative positional relationship. In such an application, it is desirable that the size of the marker 1 when viewed from the surface side of the marker 1 is equal to or less than 100 mm×100 mm. However, according to the marker 1 of the present embodiment, even such a small size enables extremely highly accurate position detection. The outer shape of the marker 1 is not limited to the above example, and may be appropriately changed to, for example, 10 mm×10 mm, 20 mm×20 mm, 40 mm×40 mm, 44 mm×44 mm, 80 mm×80 mm, or the like.

In the present embodiment, the mark 2 is configured in a circular shape, but the mark 2 is not limited to the circular shape, and may be a polygonal shape such as a triangle or a quadrangle, or another shape. The marker 1 is for use to detect the relative positional relationship between the imaging position and the marker 1 (hereinafter, also simply referred to as position detection) according to how the mark 2 is observed.

The marker 1 is configured in a thin plate-like shape by laminating a base material layer 10, a first layer 20, a second layer 30, an adhesive layer 60, and a protective layer 70 in this order from the back surface side thereof. In the description of the present specification and the claims, “lamination of layers” is not limited to a case where the layers are arranged to be directly laminated, but also includes a case where the layers are arranged to be laminated with another layer interposed therebetween. Further, a top side (a side on which the protective layer 70 is provided) in FIG. 2 is an observation side (front side).

The base material layer 10 includes a glass plate. By forming the base material layer 10 of a glass plate, it is possible to prevent the marker 1 from expanding and contracting due to temperature change and moisture absorption. The linear expansion coefficient of the glass plate is, for example, about 31.7×10⁻⁷/° C., and the dimensional change caused by the temperature change is very small. The glass plate of the base material layer used in the present embodiment is Corning® EAGLE XG®, which has a linear expansion coefficient of 3.17×10⁻⁶/° C. Measurement of the linear expansion coefficient of the glass plate is based on JIS R3102. Further, the linear expansion coefficient of ceramics is, for example, about 28×10⁻⁷/° C., and the dimensional change caused by the temperature change is very small like glass. Therefore, ceramics may be used for the base material layer. In order to suppress the dimensional change caused by the temperature change, it is desirable that the base material layer 10 has a linear expansion coefficient of 10×10⁻⁶/° C. or less. Examples of ceramics to be used for the base material layer include silicon nitride (with a linear expansion coefficient of 2.8×10⁻⁶/° C.). Specifically, the examples include DENKA SN PLATE (manufactured by Denka Company Limited). Further, other examples to be used for the base material layer include an alumina substrate (96% alumina (manufactured by Nikko Company)), an alumina zirconia substrate (manufactured by MARUWA Co., Ltd.), and an aluminum nitride substrate (manufactured by MARUWA Co., Ltd.). In the case of ceramics, measurement of the linear expansion coefficient is based on JIS R1618. It is desirable that the layer thickness of the base material layer 10 is set to 0.3 mm or more and 2.3 mm or less. If the layer thickness of the base material layer 10 is less than 0.3, additional machining may not be performed because it may crack during cutting. If the layer thickness of the base material layer 10 is above 2.3, in the case of a multi-imposition substrate described later, the weight thereof may be excessively large, so that it may be impossible to transport the substrate.

The first layer 20 is formed of a resist material colored black (first color), and is laminated on the entire surface of the base material layer 10. In FIG. 2, hatching represents black color, and the same applies to the other cross-sectional views below. In the description of the present specification and claims, “resist material” is a photosensitive resin composition material containing a pigment or a dye. The resist material constituting the first layer 20 of the present embodiment is a resist material which has lost photosensitivity as a result of performing development processing on a resist material having photosensitivity to be used in a photolithography step. Examples of the resist material to be used for the first layer 20 (in the case of black color) include PMMA, ETA, HETA, HEMA, a mixture with epoxy, and the like. Examples of the material to be colored black include carbon, titanium blackened, nickel oxide, and the like. In the present embodiment, since the first layer 20 is formed of the resist material, the surface of the first layer 20 can be formed very smoothly, which makes the first layer 20 desirable as a base for forming the second layer 30 described later. Further, since an alignment mark (not shown) when the second layer is formed can be formed on an outer peripheral portion of the first layer 20, the dimensional accuracy can be improved. It is desirable that the layer thickness of the first layer 20 (in the case of black) is set to 1 μm or more and 5 μm or less. This is because if the layer thickness of the first layer 20 is equal to or less than 1 μm, the first layer 20 may not be uniformly formed, and if the layer thickness is 5 μm or more, curing reactivity of the resin by ultraviolet rays may be insufficient.

The second layer 30 is formed of a resist material colored white (second color), and is laminated on the first layer 20 so as to be partially opened. The resist material constituting the second layer 30 of the present embodiment is a resist material which has lost photosensitivity as a result of performing development processing on a resist material having photosensitivity to be used in the photolithography step. Examples of the resist material to be used for the second layer 30 (in the case of white color) include PMMA, ETA, HETA, HEMA, a mixture with epoxy, and the like. Examples of the material to be colored white include titanium oxide, zirconia, barium titanate, and the like. The second layer 30 is partially opened by photolithography processing described later to provide opening portions 30a visualizing the first layer 20 at four locations. In other words, the second layer 30 partially conceals the first layer 20, and unconcealed regions (regions where the second layer 30 is not laminated) are the opening portions 30a. The regions of the first layer 20 which are visualized by the opening portions 30a are configured to be observable as marks 2 having independent shapes. Note that a mark having an independent shape means that a plurality of marks are not connected and each of the marks has an individually recognizable form.

It is desirable that the layer thickness of the second layer 30 (in the case of white) is set to 3 μm or more and 100 μm or less. This is because if the layer thickness of the second layer 30 is smaller than 3 μm, the first layer 20 of the base may be observed to be seen through the second layer 30, the contrast may be lowered, and the visibility of the mark 2 (easiness of detection by automatic recognition) may deteriorate. Further, this is because if the layer thickness of the second layer 30 is larger than 100 μm, in the case of observing the mark 2 in a diagonal direction, a region may increase where the first layer 20 cannot be seen due to being shaded by the second layer 30 at a peripheral edge portion of the opening portion 30a, so that the distortion of the observed shape of the mark 2 may increase.

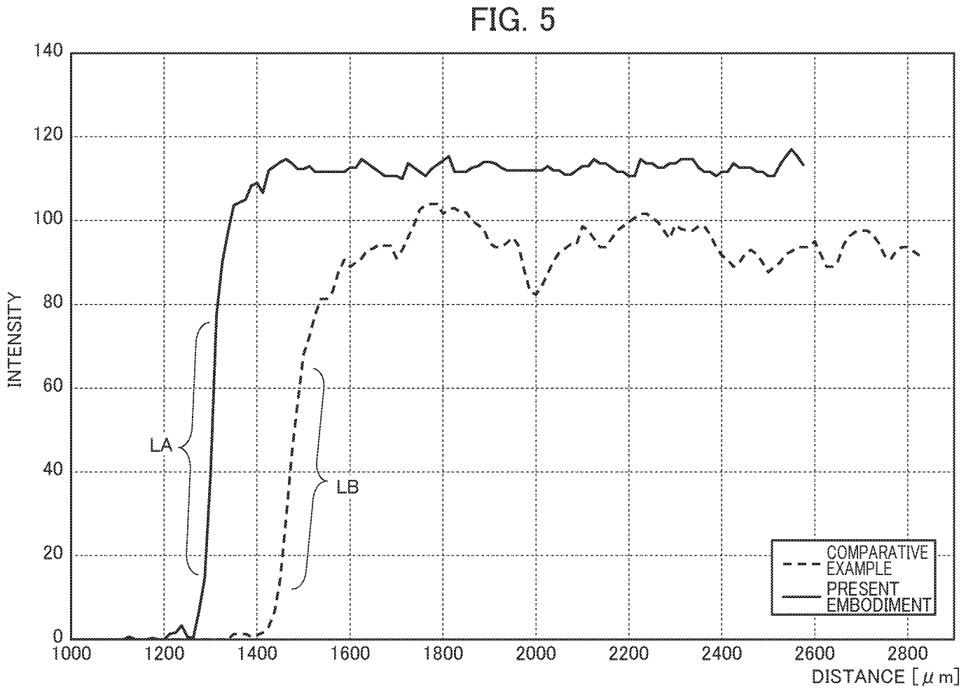

It is desirable that the mark 2 has a higher contrast value between the color of the first layer 20 and the color of the second layer 30 for more accurate detection. In the configuration of the present embodiment used under white light (visible light), it is desirable that the contrast value between the color of the first layer 20 (first color) and the color of the second layer 30 (second color) is equal to or more than 0.26, and the blur value observed between the color of the first layer 20 (first color) and the color of the second layer 30 (second color) is equal to or more than 0.17. The contrast value and the blur value will be described later with reference to FIG. 5.

The adhesive layer 60 is a layer of an adhesive for sticking the protective layer 70 onto the second layer 30. The adhesive layer 60 includes a transparent adhesive so that the first layer 20 and the second layer 30 can be observed. The adhesive layer 60 can be formed by using, for example, PMMA, urethane, silicone, or the like. It is desirable that the layer thickness of the adhesive layer 60 is set to 0.5 μm or more and 50 μm or less. This is because if the layer thickness of the adhesive layer 60 is less than 0.5 μm, uniform processing may be difficult and asperities of the base cannot be absorbed. Further, this is because if the layer thickness of the adhesive layer 60 is larger than 50 μm, it may take much time and labor to remove a solvent during thick coating processing, and the cost increases accordingly. The layer thickness of the adhesive layer 60 referred to here is the layer thickness at the position where the thickness is smallest.

The protective layer 70, which is a layer for protecting the first layer 20 and the second layer 30, is stuck onto the second layer 30 via the adhesive layer 60. The protective layer 70 has a resin base material layer 71 and a surface layer 72. The resin base material layer 71 can be configured by using, for example, vinyl chloride, polyethylene terephthalate, polycarbonate, cycloolefin polymer, triacetyl cellulose, or the like. The surface layer 72 can be configured by using, for example, an acrylic resin having a property of diffusing light by mixing fine particles, solgel, siloxane, polysilazane, or the like. However, when the surface of the resin base material layer 71 is embossed or the like such that this surface has asperities to be imparted with a property of diffusing light, the surface layer 72 may be omitted. By adding the light diffusing function to the protective layer 70 as described above, the protective layer 70 can also have a function as a light diffusion layer.

The resin base material layer 71 has the adhesive layer 60 laminated on one surface thereof and the surface layer 72 laminated on the other surface thereof. The resin base material layer 71 includes a transparent resin so that the first layer 20 and the second layer 30 can be observed. In the present embodiment, it is assumed that the marker 1 is used under visible light, and the adhesive layer 60 and the resin base material layer 71 are configured to be transparent to white light. Specifically, it is desirable that the adhesive layer 60 and the resin base material layer 71 each have a total light transmittance of 50% or more in a region where the wavelength of light is 400 nm to 700 nm. More desirably, the total light transmittance in the region where the wavelength of light is 400 nm to 700 nm is 50% or more in a state where the adhesive layer 60 and the resin base material layer 71 are measured together. It is desirable that the layer thickness of the resin base material layer 71 is set to 7 μm or more and 250 μm or less. This is because if the layer thickness of the resin base material layer 71 is less than 7 μm, lamination processing may be difficult. Further, this is also because if the layer thickness of the resin base material layer 71 is larger than 250 μm, the bulk and weight thereof may become too large, and the cost may increase accordingly. Further, it is preferable that the refractive index of the resin base material layer 71 is 1.45 or more and 1.55 or less.

The surface layer 72 may be a layer having both an antireflection function and a hard coat function. It is desirable that the surface layer 72 has a regular reflectance of 1.5% or less for light having a wavelength of 535 nm in order to prevent deterioration of the visibility of the mark 2 due to reflection from the surface of the marker 1. For example, when a ring-shaped illumination or the like arranged around the lens of a camera is used for observing the marker 1, the illumination itself may be reflected from the surface of the marker 1 and observed. In such a case, the antireflection function of the surface layer 72 prevents or suppresses surface reflection, so that the contour of the mark 2 can be recognized more clearly, and highly accurate detection can be performed accordingly. Further, it is desirable that the surface layer 72 has a hardness of 1H or higher on the scale of pencil hardness as the hard coat function. The surface layer 72 can be configured by using, for example, sol-gel, siloxane, polysilazane, or the like. Examples of a specific method for antireflection function include antireflection (AR) and antiglare (AG) method, but the AR method is preferable for recognition of the mark 2 under a condition that strong light rays such as sunlight do not specularly reflect. Under a condition that strong light rays such as sunlight may specularly reflect, the AG method is preferable for the recognition of the mark 2. The AR method is implemented by a known method such as multi-layer thin film interference or a moth-eye method. The AG method is implemented by a known method such as a method of kneading light-diffusing particles making the surface of a film to have asperities into a film or coating the same on the surface of a film.

Further, it is desirable as a characteristic of the combination of the adhesive layer 60 and the protective layer 70 that the total light transmittance is 85% or more. This is because if the total light transmittance is less than 85%, a sufficient light amount may not be secured. Further, it is desirable as a characteristic of the combination of the adhesive layer 60 and the protective layer 70 that the haze value is 30% or more, more preferably 40% or more, and yet more preferably 70% or more. This is because if the haze value is lower than 70%, an antireflection effect may start to deteriorate, when the haze value is equal to or less than 40%, the effect may further deteriorate, and when the haze value is equal to or less than 30%, the effect may deteriorate remarkably. On the other hand, it is desirable that the haze value is equal to or less than 95%. This is because if the haze value is higher than 95%, the image of an observed mark may blur.

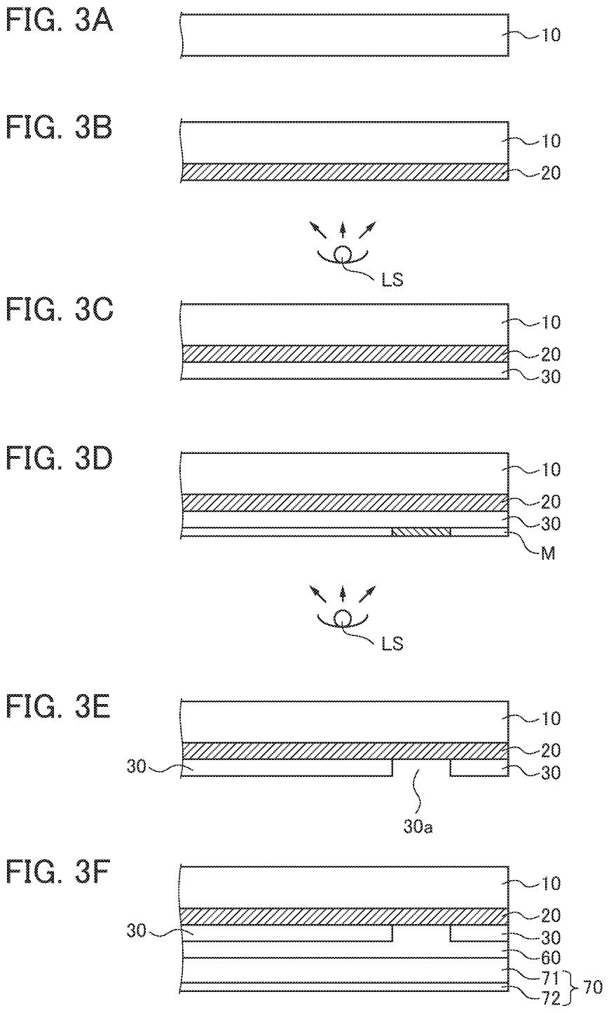

Next, a method for manufacturing the marker 1 of the present embodiment will be described. FIG. 3A to FIG. 3F are diagrams showing a manufacturing process of the marker 1. FIG. 3A to FIG. 3F show the process with the front and back (the top and bottom) being reversed with respect to that of FIG. 2. First, a glass plate is prepared and used as a base material layer 10 (FIG. 3A). Next, a black-colored resist material which will serve as the material of a first layer 20 is coated onto one surface of the base material layer 10 (first layer forming step), prebaked, and solidified. Thereafter, this material is exposed by a light source LS (first developing step), and further developed and post-baked (first baking step) to stabilize the first layer 20 (FIG. 3 B).

Next, a white-colored resist material which will serve as the material of a second layer 30 is coated onto the first layer 20 (second layer forming step), prebaked, and solidified (FIG. 3C). Next, a mask M is brought into close contact with the solidified second layer 30 to expose the second layer 30 to light via a mark pattern (second exposing step) (FIG. 3 D). A mask pattern in which light is transmitted through portions other than the portion corresponding to the mark 2 and light is shielded by the portion corresponding to the mark 2 is formed on the mask M in advance.

Next, the second layer 30 which has been exposed to light is developed to remove the resist material at the position corresponding to the mark 2, thereby forming an opening portion 30a (second developing step) (FIG. 3 E). After the development, the second layer 30 is post-baked (second baking step). Finally, a separately prepared film-shaped or sheet-shaped protective layer 70 is attached onto the second layer 30 through an adhesive layer 60 to complete the marker 1 (FIG. 3F).

Since the marker 1 of the present embodiment uses a resist material, the contour shape of the mark 2 is created with extremely high accuracy, and the observed shape of the mark 2 enables more accurate control. In order to facilitate the understanding of this fact, the contour shape of the marker 1 of the present embodiment and a comparative example are actually prepared, and a result of comparison therebetween is shown below. In the comparative example, the shape of a mark 2 was printed on a sheet of paper by using a laser printer.

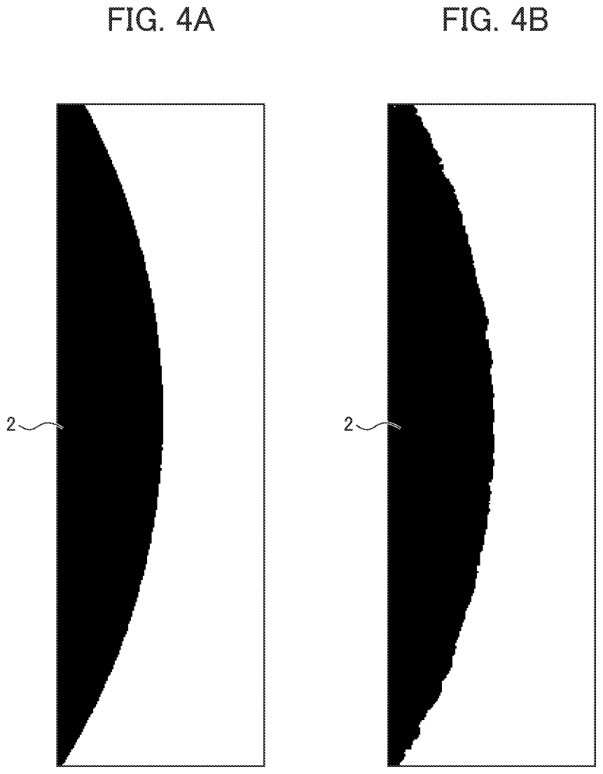

FIG. 4A and FIG. 4B are partially enlarged views showing results obtained by photographing the marks 2 of the present embodiment and the comparative example. FIG. 4A shows the present embodiment, and FIG. 4B shows the comparative example. Note that FIGS. 4A and 4B each show binarized values with an intermediate value between black and white set as a threshold value. A digital microscope VHX-5500 (1/1.8 type CMOS image sensor, effective pixel 1600 (H)×1200 (V)) manufactured by KEYENCE CORPORATION was used for photographing the marks 2. The distance between the mark 2 and the tip of the lens under photographing was set to 15 mm.

As shown in FIG. 4A, the marker 1 of the present embodiment is represented by a curve (arc) in which the contour shape of a peripheral edge portion of the mark 2 is very smooth. On the other hand, in the comparative example, although it looks like a circle when viewed from a distance, the contour shape differs largely from the arc in magnified view.

In FIGS. 4A and 4B, the photographing results are not represented because they are binarized. However, with respect to the actual photographing results, in the comparative example, existence of an intermediate gradation is remarkable instead of the two gradations of black and white. Therefore, especially in the comparative example, it is considered that the shape to be grasped as the outer shape of the mark 2 changes depending on a photographing condition (observation condition) and a method of identifying the boundary between black and white (threshold value), which is not desirable. In order to facilitate the comparison with the case of the present embodiment in this point, the change in light intensity with respect to the position change at the boundary between black and white is graphed based on photographing data.

FIG. 5 is a diagram showing the change in light intensity with respect to the change in position at the boundary between the black of the first layer 20 and the white of the second layer 30. In FIG. 5, a lower side in intensity on the vertical axis appears to be a black side, and a higher side in intensity appears to be a white side. Further, although the horizontal axis corresponds to the pixel of the photographing data, the absolute value itself thereof has no meaning because a reference position is shifted between two polygonal line data so that the two polygonal line data do not overlap each other. The change in the pixel value on the horizontal axis corresponds to the position change, and 100 pixels correspond to 1 mm. An embodiment and a comparative example in FIG. 5 are the same as the embodiment and the comparative example shown in FIG. 4, respectively.

As described above, it is desirable that the contrast value between the color of the first layer 20 (first color) and the color of the second layer 30 (second color) is equal to or more than 0.26. The reason why it is desirable that the contrast value is equal to or more than 0.26 resides in that if the contrast value is less than 0.26, the automatic detection of the mark 2 using the camera is considered to be difficult. Here, the contrast value=(Imax−Imin)/(Imax+Imin) when the maximum value of the light intensity is represented by Imax and the minimum value thereof is represented by Imin. In the example shown in FIG. 5, the contrast value of the present embodiment was equal to 0.98, and the contrast value of the comparative example was equal to 0.98, so that no significant difference could be confirmed between both the contrast values.

Further, as described above, it is desirable that the blur value observed between the color of the first layer 20 (first color) and the color of the second layer 30 (second color) is equal to or more than 1.0. Especially when the mark is used for high-accuracy control, it is not desirable that the boundary of the mark is ambiguous. Therefore, it is desirable that the change in intensity at the boundary portion between the black side and the white side is like a rectangular wave or the change is steep. The changes in intensity at the boundary portion between the black side and the white side were quantified from the data of FIG. 5, and compared with each other. Specifically, the data in ranges shown as LA and LB in the polygonal lines in FIG. 5 were quantified based on gradients thereof. Here, the ranges LA and LB are determined so that the ranges LA and LB can be sufficiently linearly approximated. In other words, approximation straight lines are determined for ranges in which the change in intensity is great, and ranges in which the measurement data do not deviate are determined as the ranges LA and LB. In the above ranges LA and LB, (the change amount in intensity)/(the change amount in pixel) was determined as the gradient value (blur value) of the change in intensity. As a result, in the present embodiment, the gradient value (blur value) of the change in intensity was equal to 1.29. On the other hand, in the comparative example, the gradient value (blur value) of the change in intensity was equal to 0.87. As described above, a clear difference is observed between both the embodiment and the comparative example, and the configuration of the present embodiment is a desirable one closer to the ideal.

As described above, according to the present embodiment, photolithography is used, so that it is possible to easily perform manufacturing without requiring any high-accuracy machining, and it is possible to obtain a high-accuracy marker. Further, with respect to the marker 1 of the present embodiment, the thickness of the second layer 30 can be made very small. Accordingly, it can be suppressed that the shape of the mark 2 is observed as being distorted even when the mark 2 is observed in a diagonal direction. As a result, more accurate position detection is implemented.

### Second Embodiment

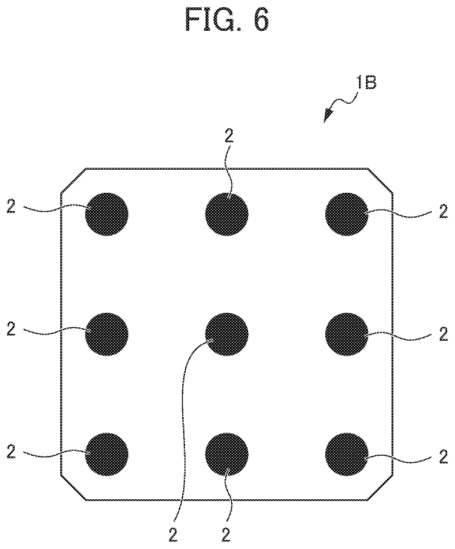

FIG. 6 is a diagram showing a marker 1B of a second embodiment. The marker 1B of the second embodiment has the same form as the marker 1 of the first embodiment except that a larger number of marks 2 are arranged. Therefore, the same reference numerals are given to portions that perform the same functions as those of the first embodiment described above, and duplicative description thereon will be omitted on an as-needed basis.

In the marker 1B of the second embodiment, a larger number of marks 2 are arranged as compared with the first embodiment. Specifically, nine marks 2 are arranged on the marker 1B to be spaced from one another at intervals in a grid pattern. As described above, it is desirable that at least three marks 2 are arranged. This is because, for example, if the positions of the centers of gravity of the marks 2 are calculated at three points from an observation result of the marks 2, the relative position and inclination between the observation position (camera or the like) and the marker 1 can be accurately detected. Further, if the number of marks 2 is larger than 3, for example, the position detection can be performed from an observation result of the remaining marks 2 when some marks 2 are unclearly observed due to some kind of obstacle. By using a plurality of marks 2, the accuracy of position detection can be improved.

In the second embodiment, the number of marks 2 is set to 9, which is significantly increased as compared with the first embodiment. As a result, in addition to the above effect, the following effect can be expected. For example, even when there are many marks 2 that are not properly photographed (observed) because half or more of the areas of markers 1B cannot be properly photographed (observed), it is possible to enhance the possibility that the position detection can be appropriately performed by photographing (observing) the remaining marks 2. A situation in which half or more of the areas of the markers 1B cannot be properly photographed (observed) includes, for example, a situation in which sunlight directly hits half or more of the areas of the markers 1B and no sunlight hits the remaining areas. In such a case, if the exposure (gain) is properly adjusted for one side, the other side would be overexposed or underexposed. Further, this can also be illustrated in a case where another object physically overlaps a part of the optical axis of photography and half or more of the areas of the markers 1B cannot be photographed (observed).

Assuming a substantially square marker as shown in FIG. 6, it is desirable that the number of marks 2 is set to nine or more because it is easy to arrange the marks 2 evenly. The number of marks 2 may be further increased, and the arrangement thereof may include not only uniform arrangement, but also so-called a random arrangement in which the marks 2 are randomly arranged. Even in the case of random arrangement, the position detection can be easily performed if the arrangement data of the marks 2 in the marker 1B is obtained. Even in a case where the relationship between the marker 1B and the photographing position (observation position) is shifted by a half rotation, the relative positional relationship therebetween can be accurately grasped by the random arrangement.

As described above, according to the second embodiment, the marker 1B includes nine or more marks 2. Therefore, the position detection can be appropriately performed even under a stricter photographing condition (observation condition).

### Third Embodiment

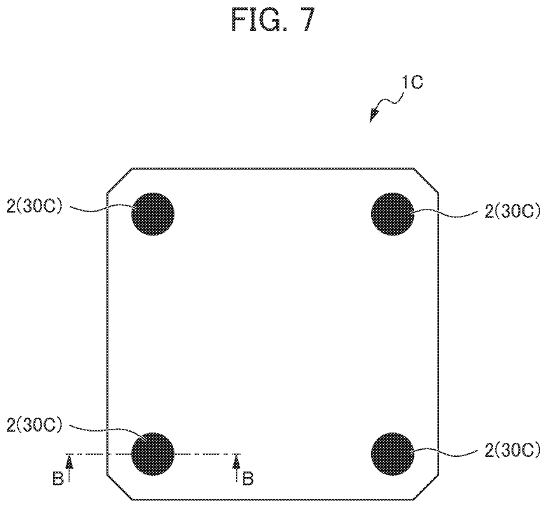

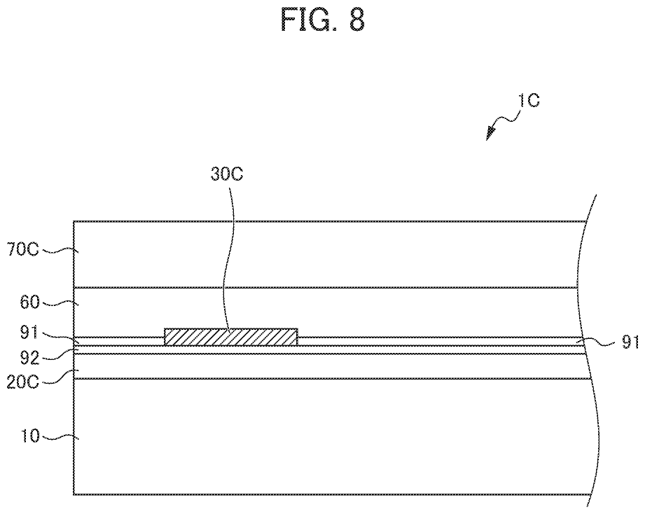

FIG. 7 is a diagram showing a marker 1C of a third embodiment. FIG. 8 is a cross-sectional view of a marker which is cut at the position of an arrow B-B in FIG. 7. The marker 1C of the third embodiment has the same form as the marker 1 of the first embodiment except that an observed form of the mark is set to the same as that of the first embodiment, but a first layer 20C is set to white color and a second layer 30C on the observation side is set to black color, a flattening layer 91 and an intermediate layer 92 are provided, and a form of the protective layer 70C is different. Therefore, the same reference numerals are given to portions that perform the same functions as those of the first embodiment described above, and duplicative description thereon will be omitted on an as-needed basis.

The marker 1C of the third embodiment is configured in a thin plate-like shape by laminating a base material layer 10, the first layer 20C, the intermediate layer 92, the second layer 30C, an adhesive layer 60, and the protective layer 70C in this order from the back surface side thereof. Further, the flattening layer 91 is provided in a peripheral region where the second layer 30C is not provided.

The first layer 20C is formed of a resist material colored white (first color), and is laminated on the entire surface of the base material layer 10. In the present embodiment, the base material layer 10 is made of non-alkali glass having a thickness of 700 μm. In the present embodiment, since the first layer 20C is formed of the resist material, the surface of the first layer 20C can be formed very smoothly, which makes the first layer 20c desirable as a base for forming the second layer 30C described later. Further, the dimensional accuracy can be improved since an alignment mark (not shown) can be formed on the outer peripheral portion of the first layer when the second layer is formed. It is desirable that the layer thickness of the first layer 20C (in the case of white) is set to 3 μm or more and 100 μm or less. This is because the diffuse reflectance may be insufficient if the layer thickness of the first layer 20C is smaller than 3 μm, so that the contrast may lower and the visibility of the mark 2 (easiness of detection by automatic recognition) may lower accordingly. Further, this is also because if the layer thickness of the first layer 20C is larger than 100 μm, it may be difficult to make the film thickness uniform. In the present embodiment, the layer thickness of the first layer 20C is set to 15 μm.

The second layer 30C is formed of a resist material colored black (second color). A film of the second layer 30C is partially formed by photolithography processing described later, thereby providing four sites where the first layer 20C is concealed by the film of the second layer 30c. The region of the second layer 30C is observably configured as a mark 2 having an independent shape.

It is desirable that the layer thickness of the second layer 30C is 1 μm or more and 5 μm or less. This is because if the layer thickness of the second layer 30C is 1 μm or less, it may not be uniformly formed, and if the layer thickness is 5 μm or more, the curing reactivity of the resin by ultraviolet rays may be insufficient. In the third embodiment, the second layer 30C, which is colored black, has a high concealing capacity for concealing the base. Therefore, it is possible to make the layer thickness as small as described above since the white color of the first layer 20C can be sufficiently concealed without thickening the second layer 30C. By forming the second layer 30C thinly, it is possible to suppress deterioration in measurement accuracy due to the observation of the end surface of the second layer 30C, and it is possible to improve the measurement accuracy accordingly. In the present embodiment, the layer thickness of the second layer 30C is set to 1 μm.

In the marker 1C of the present embodiment, the intermediate layer 92 is laminated between the first layer 20C and the second layer 30C. The intermediate layer 92 is provided in order to cope with a case where the bonding force between the first layer 20C and the second layer 30C is not sufficiently obtained. When the second layer 30C is directly laminated on the first layer 20C, the second layer 30C may be repelled by the first layer 20C. In such a case, the second layer 30C can be properly laminated by laminating the intermediate layer 92 which is difficult to be repelled. Therefore, the intermediate layer 92 may be provided as needed, and may be omitted as in the first embodiment. The intermediate layer 92 can be formed by using, for example, an acrylic resin, and a layer thickness of about 1 μm to 2 μm is sufficient. In the present embodiment, acrylic resin having a layer thickness of 2 μm is formed.

Since the first layer 20 or 20C is laminated on the base material layer 10 and the second layer 30 or 30C is further laminated on the first layer 20 or 20C, a level difference occurs in the patterned second layer 30 or 30C. In the case of the second layer 30 of the first embodiment, the cross-sectional shape of the portion corresponding to the mark 2 is concave. On the other hand, in the case of the second layer 30C of the third embodiment, the cross-sectional shape of the portion corresponding to the mark 2 is convex.

Therefore, when the protective layer 70 described later is stuck, the above-mentioned level difference is filled with the adhesive layer 60 to some extent. However, if the level difference is large, it cannot be filled with the adhesive layer, and there may be a risk that an air layer (void) intrudes in the vicinity of the level difference accordingly. The refractive index of the air layer is 1, which is clearly lower than the refractive index of 1.4 to 1.6 of the base material, etc. Therefore, reflection of light occurs at the interface of the substance, and it causes stray light when the mark 2 is detected by the camera, so that the detection accuracy is significantly deteriorated. Therefore, in order to suppress the occurrence of the air layer, the film thicknesses of the second layers 30 and 30C are equal to 5 μm or less, more preferably 3 μm or less, and yet more preferably 2 μm or less.

However, as in the first embodiment described above, when the second layer 30 is colored white, the concealing capacity for concealing the base is inferior to that of black color. Therefore, it may not be desirable that the thickness is made smaller, and the above-mentioned level difference may be large. Therefore, if the above-mentioned level difference cannot be set to 5 μm or less, a flattening layer 91 is provided in a region around the second layers 30 and 30C in which the second layers 30 and 30C are not provided, so that it is possible to prevent the air layer from intruding. It is preferable that the flattening layer 91 is formed of a transparent material which enables identification of the mark 2, and known materials such as acrylic materials and epoxy materials can be used. The third embodiment illustrates a form in which the flattening layer 91 is provided to reduce the level difference. By providing the flattening layer 91, the level difference between the second layer 30C and the flattening layer 91 can be further reduced. In the third embodiment, the flattening layer 91 may alternatively be omitted because the second layer 30C, which is black and has a high concealing capacity, can be formed thinly.

The protective layer 70C is a layer for protecting the first layer 20C and the second layer 30C, and is stuck onto the second layer 30C and the flattening layer 91 via the adhesive layer 60. In the third embodiment, the protective layer 70C illustrates an example in which it is formed by a single layer, and specifically, a matte film which is formed of a vinyl chloride resin at 70 μm and has a haze value of 75 is used.

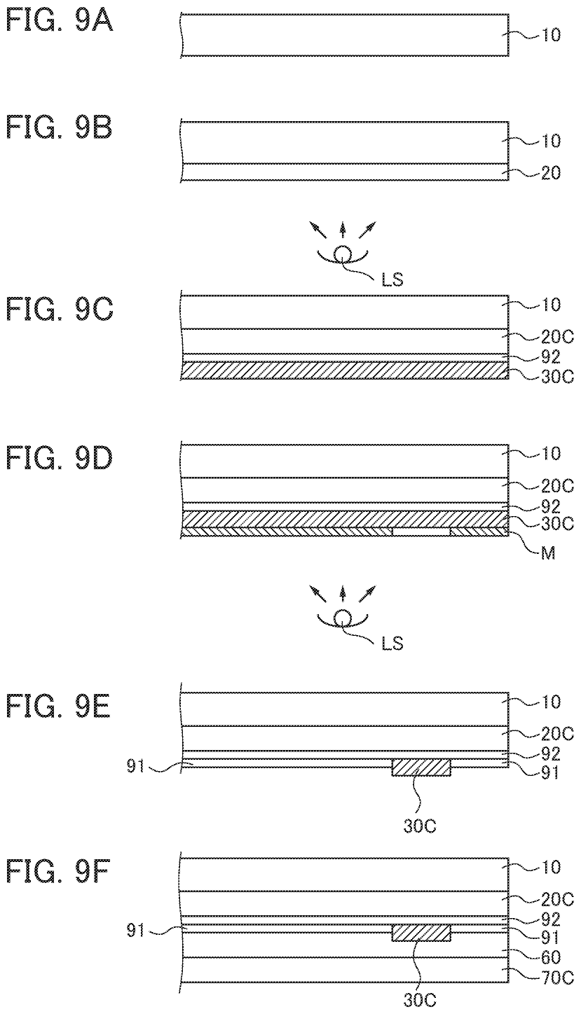

Next, a method for manufacturing a marker 1C of the present embodiment will be described. FIG. 9A to FIG. 9F are diagrams showing a manufacturing process of the marker 1C. Note that FIGS. 9A to 9F shows the front and back (top and bottom) which are reversed with respect to that in FIG. 8. First, a glass plate is prepared and used as a base material layer 10 (FIG. 9A). Next, a white-colored resist material which serves as the material of a first layer 20 is coated onto one surface of the base material layer 10 (first layer forming step), prebaked, and dried, and thereafter, this resultant material is exposed by a light source LS (first developing step), further developed and post-baked (first baking step) to stabilize the first layer 20C (FIG. 9B). Next, an intermediate layer 92 is formed on the first layer 20C, and a black-colored resist material serving as a material for a second layer 30C is further coated onto the intermediate layer 92 (second layer forming step), pre-baked and dried (FIG. 9C). Next, a mask M is brought into close contact with the dried second layer 30C to expose the second layer 30C to light via the mark pattern (second exposure step) (FIG. 9 D). A mask pattern in which light is transmitted through the position corresponding to a mark 2 and light is shielded by the other positions is formed on the mask M in advance.

Next, the second layer 30C which has been exposed to light is developed to remove the resist material at the portion other than the portion corresponding to the mark 2 (around the mark 2), thereby forming an opening portion 30a (second developing step) (FIG. 9E). After the development, the second layer 30C is post-baked (second baking step). Further, the flattening layer 91 is provided in a region where the second layer 30C is not formed (a region where the resist material is removed). Finally, a separately prepared film-shaped or sheet-shaped protective layer 70 is stuck onto the second layer 30C and the flattening layer 91 by an adhesive layer 60 to complete the marker 1C (FIG. 9F).

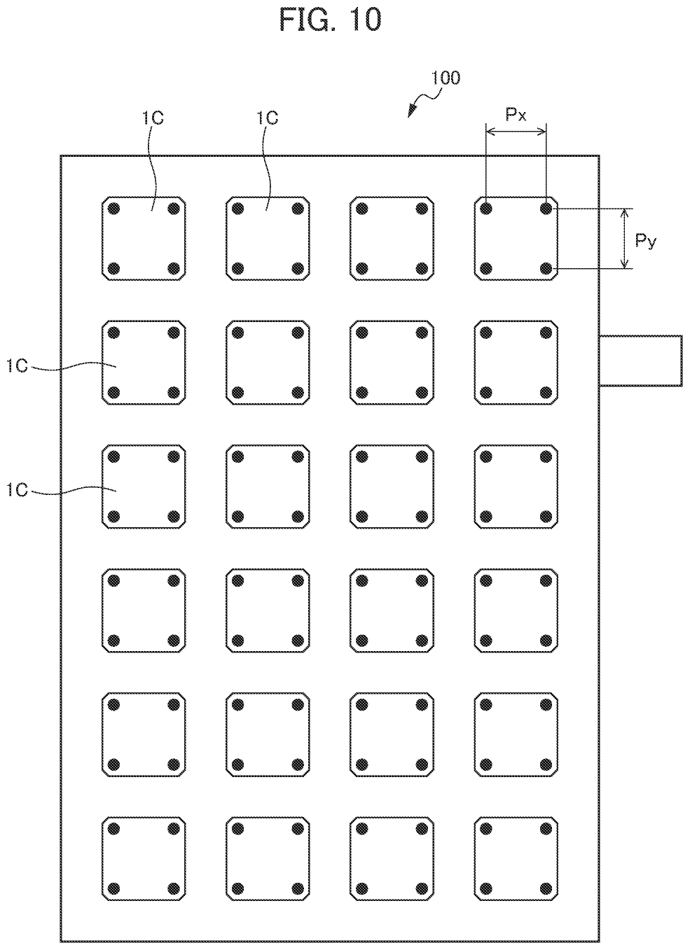

FIG. 10 is a diagram showing a marker multi-imposition body 100. In the manufacturing of the marker 1C described with reference to FIG. 9, a plurality of markers 1C are manufactured as a marker multi-imposition body 100 in which the plurality of markers 1C are arranged side by side, that is, the plurality of markers 1C are arranged in a multi-imposition style. Individual markers 1C are obtained by cutting out and individualizing the markers 1C from this marker multi-imposition body 100. In the above manufacturing process, the resist material and the exposure process are used, so that highly accurate manufacturing is implemented. In other words, the dimensional variation in the external shapes of the marks 2 on one multi-imposition body 100 and the dimensional variation in the arrangement pitches between the marks 2 in each marker 1C can be set to ±10 μm or less. More specifically, in the present embodiment, the dimensional variation in the external shapes of the marks 2 on one multi-imposition body 100 and the dimensional variation in the arrangement pitches between the marks 2 in each marker 1C are each set to ±1 μm or less. In the present embodiment, the external shape of the mark 2 corresponds to the diameter of the mark 2, and the arrangement pitches between the marks 2 in each marker 1C corresponds to Px and Py shown in FIG. 10.

As described above, according to the third embodiment, the second layer 30C provided on the observation side is colored black, and the first layer 20C is colored white. As a result, the second layer 30C has a higher concealing capacity for concealing the base, so that the layer thickness of the second layer 30C can be made smaller than that of the first embodiment. Therefore, when observing the mark 2 configured by the second layer 30C, the influence on the measurement accuracy by the observation of the side end surface of the second layer 30C can be suppressed as much as possible, and the measurement with higher accuracy can be performed accordingly. Further, according to the third embodiment, by providing the flattening layer 91, it is possible to suppress the occurrence of voids caused by the lamination of the adhesive layer 60, and accordingly it is possible to suppress the deterioration of the measurement accuracy.

With respect to the markers 1, 1B and 1C of the first to third embodiments described above, the protective layer 70, 70C is laminated and arranged via the adhesive layer 60. With this configuration, the markers 1, 1B and 1C have very high reliability. For example, when some object collides with the marker 1, 1B, 1C during use, it may be considered that the base material layer 10 is cracked because the base material layer 10 is a glass plate. However, since the protective layer 70, 70C is laminated via the adhesive layer 60, the protective layer 70, 70C functions as a shatter-proof layer to prevent fragments of the base material layer 10 from scattering. Even when the base material layer 10 is cracked, the first layers 20, 20C and the second layer 30, 30C can maintain the function as the marker without being damaged.

The reason for this is that it is inferred that the first layers 20, 20C and the second layer 30, 30C follow the adhesive layer 60 since the bonding force of the first layers 20, 20C and the second layers 30, 30C to the base material layer 10 is weaker than the bonding force thereof to the adhesive layer 60, whereby they are prevented from being damaged. Therefore, it is desirable that the bonding force of the first layers 20, 20C and the second layers 30, 30C to the base material layer 10 is weaker than the bonding force of the first layers 20, 20C and the second layers 30, 30C to the adhesive layer 60. It has been verified by a drop test using an actual product that the first layers 20, 20C and the second layers 30, 30C are not damaged even if the base material layer 10 is cracked.

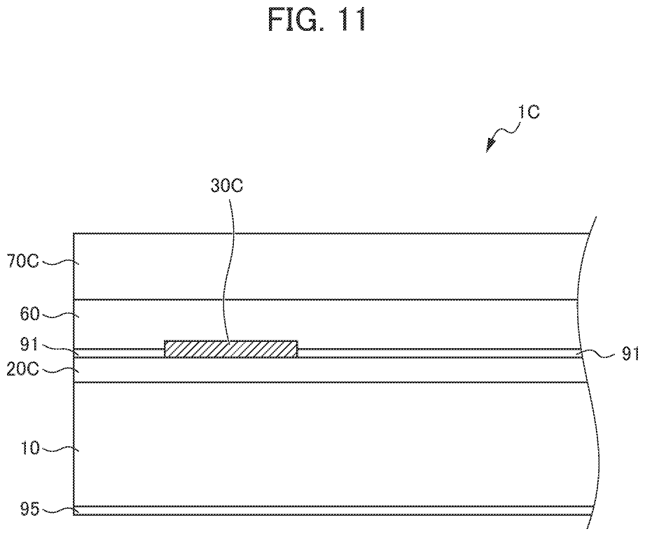

Further, as described above, even if the base material layer 10 is cracked, the cracks in the base material layer 10 cannot be confirmed when viewed from the observation side. Therefore, a sensor for detecting damage may be provided on the back side of the base material layer 10. FIG. 11 is a diagram showing a form in which an electrode layer 95 is provided. The electrode layer 95 can be formed on substantially the entire surface of the back side of the base material layer 10, and is allowed to function as a sensor for detecting damage. The electrode layer 95 may be formed of, for example, ITO, copper foil, aluminum foil, or the like, but when the base material layer 10 is damaged, it is necessary that the electrode layer 95 is damaged together with the base material layer 10. If the electrode layer 95 is damaged and the electric resistance value thereof changes, damage to the base material layer 10 is detectable by electrically monitoring the electrode layer 95. Further, by forming the electrode layer 95 with a material such as a metal having high light reflectivity, it is possible to improve the visibility of the mark 2 at a dark place by reflecting external light and detection light at the electrode layer 95. When the electrode layer 95 is provided, the protective layer 70C may be omitted.

### Fourth Embodiment

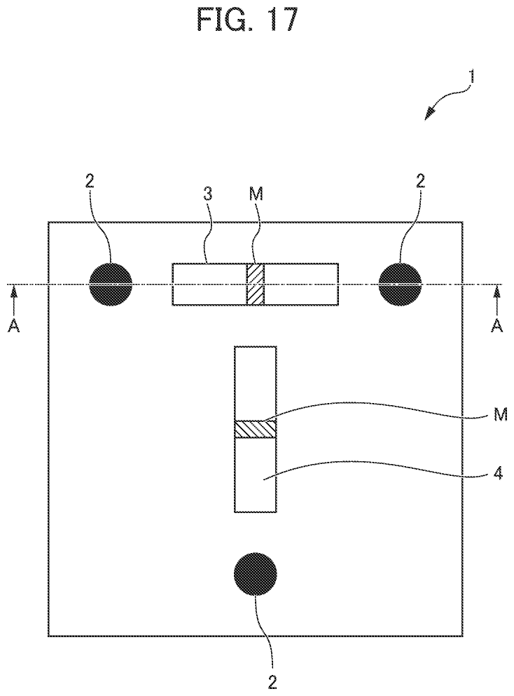

FIG. 17 is a diagram showing a fourth embodiment of the marker according to the present invention. The following figures including FIG. 17 are schematic diagrams, and the sizes and shapes of respective parts are presented by being exaggerated or omitted as appropriate to facilitate understanding thereof. Further, the following description will be made while presenting specific numerical values, shapes, materials, and the like, but these may be changed as appropriate. In the present specification, terms such as plate, sheet, and film are used. The terms of plate, sheet, and film are generally used in the decreasing order of thickness, and these terms are also used in the same way in the present specification. However, such a manner of use has no technical meaning, and thus these terms may be replaced on an as-needed basis. Further, in the present invention, a “transparent” substance means a substance which transmits therethrough light having at least a wavelength to be used. For example, if a substance transmits infrared rays although it does not transmit visible light, the substance shall be treated as a transparent substance when used for applications using infrared rays. It should be noted that specific numerical values specified in the present specification and the claims should be treated as including a general error range. In other words, a difference of about ±10% is substantially the same, and a value set in a range slightly beyond the numerical range of the present invention should be interpreted as being substantially within the numerical range of the present invention.

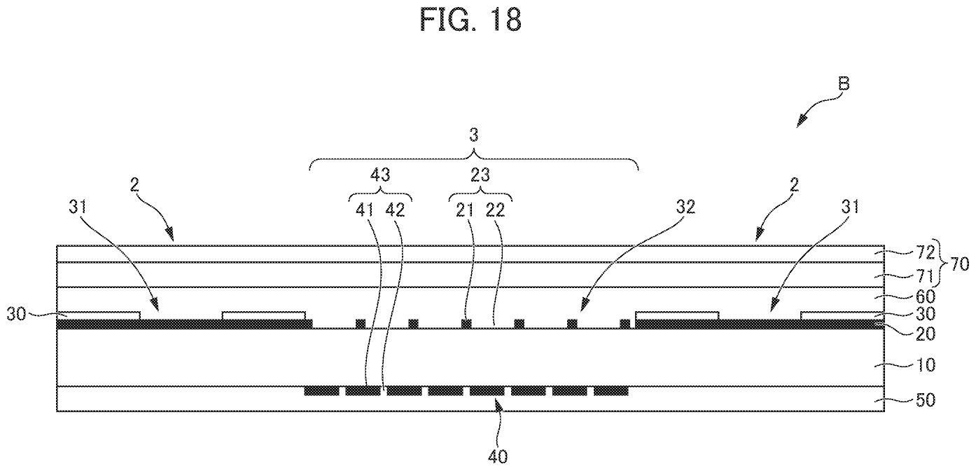

As shown in FIG. 17, a marker 1 is configured like a plate having a substantially square shape when viewed from the normal direction of a surface on which a protective layer 70 described later is provided, and includes marks 2 and moire display regions 3 and 4. In the present embodiment, the marker 1 is formed so that the shape thereof when viewed from the surface side is a square shape of 60 mm×60 mm. The marker 1 detects the relative positional relationship between the photographing position and the marker 1 according to how the marks 2 are observed (hereinafter, also simply referred to as position detection), and further, the position detection can be performed with higher accuracy according to how moire displayed in the moire display regions 3 and 4 is observed. With respect to the marker 1, a surface shown in FIG. 17 is a front side (front surface) to be observed, an opposite side thereto is a back side (back surface), and in FIG. 18 described later, a side on which the protective layer 70 is provided is the front side (front surface) to be observed.

The marks 2 are arranged at two places near two upper corners and at one place near the lower center in the right-and-left direction in FIG. 17, that is to say, totally three marks are arranged to be spaced from one another. Each mark 2 is configured to be observable as a mark having an independent shape. Note that a mark having an independent shape means that a plurality of marks are not connected and each of the marks has an individually recognizable form. It is desirable that at least three marks 2 are arranged. This is because, for example, if the positions of the centers of gravity of the marks 2 are calculated at three points from an observation result of the marks 2, the relative position and inclination between the observation position (camera or the like) and the marker 1 can be accurately detected. Further, if the number of marks 2 is larger than 3, for example, the position detection can be performed from an observation result of the remaining marks 2 when some marks 2 are unclearly observed due to some kind of obstacle. By using a plurality of marks 2, the accuracy of position detection can be improved. In the present embodiment, each mark 2 is configured in a circular shape, but not limited to the circular shape, and may be a polygonal shape such as a triangle or a quadrangle, or another shape.

The moire display regions 3 and 4 display moires M. FIG. 17 shows a state in which the moires M are displayed in the centers of the moire display regions 3 and 4 in both the moire display regions 3 and 4. The position where a moire M is displayed shifts when the relative position (angle) between the marker 1 and the observation position changes. In the present embodiment, each of the moire display regions 3 and 4 has a length of 30 mm in the longitudinal direction, and the display position of the moire M shifts along the longitudinal direction. The moire display region 3 and the moire display region 4 are arranged so that their longitudinal directions are orthogonal to each other. Since the display regions 3 and 4 have the same configuration except that the arrangement directions thereof are different from each other, the display region 3 will be described below.

FIG. 18 is a cross-sectional view of a marker which is cut at the position of arrows A-A in FIG. 17. The marker 1 is configured like a thin plate, including a base material layer 10, a first layer 20, a second layer 30, a third layer 40, a reflective layer 50, an adhesive layer 60, and a protective layer 70. The laminating order of these layers is an order of the reflective layer 50, the third layer 40, the base material layer 10, the first layer 20, the second layer 30, the adhesive layer 60, and the protective layer 70 from the back surface side.

The base material layer 10 includes a glass plate. By forming the base material layer 10 of a glass plate, it is possible to prevent the marker 1 from expanding and contracting due to temperature change and moisture absorption. The linear expansion coefficient of the glass plate is, for example, about 31.7×10⁻⁷/° C., and the dimensional change caused by the temperature change is very small. The glass plate of the base material layer used in the present embodiment is Corning® EAGLE XG®, which has a linear expansion coefficient of 3.17×10⁻⁶/° C. Measurement of the linear expansion coefficient of the glass plate used for the base material layer 10 is based on JIS R3102. Further, the linear expansion coefficient of ceramics is, for example, about 28×10⁻⁷/° C., and the dimensional change caused by the temperature change is very small like glass. Therefore, ceramics may be used for the base material layer. In order to suppress the dimensional change caused by the temperature change, it is desirable that the base material layer 10 has a linear expansion coefficient of 35×10⁻⁶/° C. or less. Examples of ceramics to be used for the base material layer include silicon nitride (with a linear expansion coefficient of 2.8×10⁻⁶/° C.). Specifically, the examples include DENKA SN PLATE (manufactured by Denka Company Limited). Further, other examples to be used for the base material layer include an alumina substrate (96% alumina (manufactured by Nikko Company)), an alumina zirconia substrate (manufactured by MARUWA Co., Ltd.), and an aluminum nitride substrate (manufactured by MARUWA Co., Ltd.). In the case of ceramics, measurement of the linear expansion coefficient is based on JIS R1618. It is desirable that the layer thickness of the base material layer 10 is set to 0.3 mm or more and 2.3 mm or less. This is because if the layer thickness of the base material layer 10 is less than 0.3 mm, additional machining cannot be performed because the base material layer 10 cracks during the cutting processing, and if the layer thickness is larger than 2.3 mm, the weight is too large, and cannot be transported. The layer thickness of the base material layer 10 of the present embodiment is set to 0.7 mm.

The first layer 20 is formed of a resist material colored black (first color). The resist material constituting the first layer 20 of the present embodiment is a resist material which has lost photosensitivity as a result of performing developing processing on a resist material having photosensitivity to be used in the photolithography step. Examples of the resist material to be used for the first layer 20 (in the case of black color) include PMMA, ETA, HETA, HEMA, a mixture with epoxy, and the like. Examples of the material to be colored black include carbon, titanium blackened, nickel oxide, and the like. In the present embodiment, since the first layer 20 is formed of the resist material, the surface of the first layer 20 can be formed very smoothly, which makes the first layer 20 desirable as a base for forming the second layer 30 described later. Further, since the first layer 20 is formed of the resist material, a first pattern 23 described below can be manufactured accurately and easily. It is desirable that the layer thickness of the first layer 20 (in the case of black) is set to 1 μm or more and 5 μm or less. This is because if the layer thickness of the first layer 20 is 1 μm or less, it cannot be uniformly formed, and if the layer thickness of the first layer 20 is greater than 5 μm, the curing reactivity of the resin by ultraviolet rays is insufficient.

The first layer 20 constitutes a portion of the mark 2 that appears black. Further, the first layer 20 constitutes a first pattern 23 for displaying a moire in the moire display region 3. The first pattern 23 is arranged in a region serving as the moire display region 3 on one surface (on the front surface) of the base material layer 10. In the first pattern 23, first display lines 21 are arranged at equal intervals in a constant arrangement direction in the longitudinal direction of the moire display region 3. A portion which is located between an adjacent pair of first display lines 21 and in which no first display line 21 is provided is a first non-display region 22, and the first display lines 21 and the first non-display regions 22 are alternately arranged. The first pattern 23 is formed by photolithography processing.

The second layer 30 is formed of a resist material colored white (second color). The resist material constituting the second layer 30 of the present embodiment is a resist material which has lost photosensitivity as a result of performing developing processing on a resist material having photosensitivity to be used in the photolithography step. Examples of the resist material to be used for the second layer 30 (in the case of white color) include PMMA, ETA, HETA, HEMA, a mixture with epoxy, and the like. Examples of the material to be colored white include titanium oxide, zirconia, barium titanate, and the like. The second layer 30 has opening portions 31 formed at three locations at which the portions corresponding to the marks 2 are opened to visualize the first layer 20, and has opening portions 32 formed at two locations at which the portions corresponding to the moire display regions 3 and 4 are opened to visualize the first layer 20 and the third layer 40. These opening portions 31 and the opening portions 32 are formed by photolithography processing.

It is desirable that the layer thickness of the second layer 30 is set to 3 μm or more and 100 μm or less. This is because if the layer thickness of the second layer 30 is smaller than 3 μm, the first layer 20 of the base may be observed to be seen through the second layer 30, the contrast may lower, and the visibility of the mark 2 (easiness of detection by automatic recognition) may deteriorate. Further, this is because if the layer thickness of the second layer 30 is larger than 100 μm, in the case of observing the mark 2 in a diagonal direction, a region may increase where the first layer 20 cannot be seen due to shading by the second layer 30 at the peripheral edge portion of the opening portion 31, so that the distortion of the observed shape of the mark 2 may increase.

The third layer 40 is formed of a resist material colored black (first color). The third layer 40 of the present embodiment includes the same material as the first layer 20, and a preferable film thickness is also the same as that of the first layer 20. Since the third layer 40 is formed of the resist material, a second pattern 43 described below can be accurately and easily manufactured.

The third layer 40 is provided with a second pattern 43 for displaying the moire in the moire display region 3. The second pattern 43 is arranged to face the first pattern 23 in a region serving as the moire display region 3 on the back surface of the base material layer 10. In the present embodiment, the first pattern 23 is provided on one surface of the base material layer 10, and the second pattern 43 is provided on the other surface. However, the first pattern 23 and the second pattern 43 may be configured so that they are provided on different base materials or the like, and then bonded to each other. In the second pattern 43, second display lines 41 are arranged at equal intervals in a constant arrangement direction in the longitudinal direction of the moire display region 3. A portion between an adjacent pair of second display lines 41 in which no second display line 41 is provided is a second non-display region 42, and the second display lines 41 and the second non-display regions 42 are alternately arranged. The second pattern 43 is formed by photolithography processing.

The reflective layer 50 is a layer for reflecting light arriving from the front side (observation side) of the marker 1 through the opening portion 32 to the front side. The reflective layer 50 can be configured by using, for example, PMMA, ETA, HETA, HEMA, or a mixture with epoxy, and the like, and it is desirable that reflective layer 50 is white in order to enhance the contrast to the first display lines 21 and the second display lines 41. Examples of the material to be colored white include titanium oxide, zirconia, barium titanate, and the like.

Here, the reflective layer 50 may be configured to be laminated in close contact with the marker 1 so as to be integrated with the marker 1 as in the present embodiment, or may be configured such that a reflective member or the like as another member is arranged on the back surface side of the marker 1. However, from the viewpoint of enabling the moire M to be seen more easily, the configuration of the present embodiment in which the reflective layer 50 is laminated and arranged in close contact with the marker 1 so as to be integrated with the marker 1 is more desirable. The reason for this will be described below.

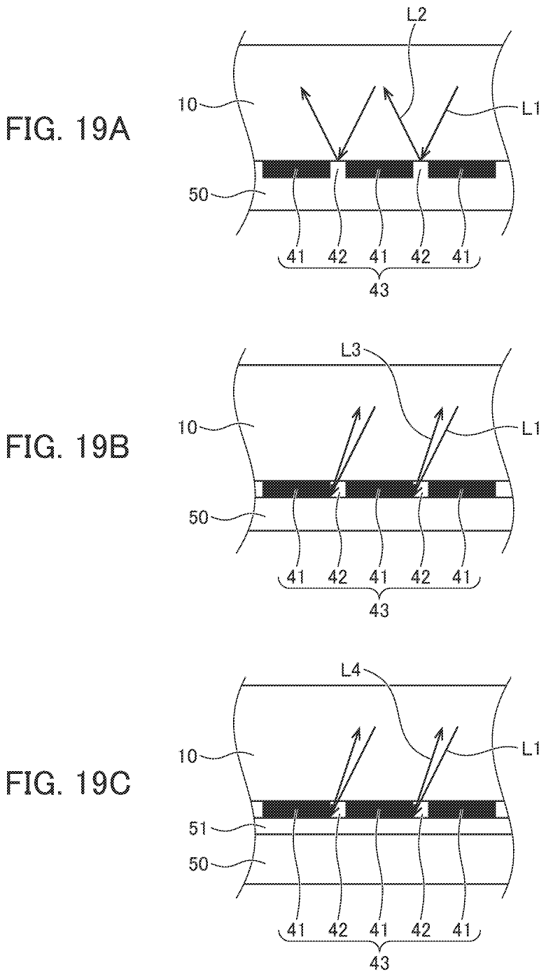

Moire M which is essentially desired to be observed is moire which is observed due to interference between the first display lines 21 and the second display lines 41. However, unnecessary moire (extra noise image) occurs due to only the first display lines 21 or only the second display lines 41 under some conditions. FIG. 19A to FIG. 19C are enlarged views of the vicinity of the second pattern 43 in order to explain a cause of the occurrence of unnecessary moire. FIG. 19A shows a configuration in which the reflective layer 50 is laminated to fill the second non-display regions 42. FIG. 19B shows a configuration in which the reflective layer 50 is laminated without filling the second non-display regions 42. FIG. 19 C shows a configuration in which the reflective layer 50 is laminated and arranged via a bonding layer 51 such as an adhesive layer. When the second non-display regions 42 are not filled with the reflective layer 50 as in forms of FIGS. 19B and 19C, light L1 incident from the observation side reflects off end portions of the second display lines 41, etc. to return to the observation side, which causes unnecessary light L3 and L4. It is considered that unnecessary moires may occur since such unnecessary light L3 and L4 occur periodically. On the other hand, in the configuration in which the reflective layer 50 is laminated to fill the second non-display regions 42 as shown in FIG. 19A, light cannot reach the end portions of the second display lines 41, etc., so that normal reflection light L2 returns to the observation side. Accordingly, it is possible to suppress occurrence of unnecessary moire and observe clear moire. In this manner, it is considered that when unnecessary moire of the second display lines 41 occurs due to light which scatters at side surface portions of the second display lines 41, that is, at the end surface portions of the second display lines 41 existing on the second non-display region 42 side and returns to an observer side, the unnecessary moire interferes with moire M that is essentially desired to be seen, which disturbs observation of the moire M. Accordingly, the reflective layer 50 is provided so as to fill the second non-display regions 42, whereby the above phenomenon can be avoided and the moire M can be observed more clearly. For the above reason, the reflective layer 50 may be provided at least in the second non-display regions 42. However, as shown in FIG. 18, it is desirable that the reflective layer 50 is provided so as to cover the back surface sides of the second display lines 41. The reason for this resides in that the bounce of light from the edge portions on the back surface sides of the second display lines 41 is suppressed, and the main component of periodic bounce light can be eliminated.

The adhesive layer 60 is a layer of an adhesive for sticking the protective layer 70 onto the second layer 30. The adhesive layer 60 includes a transparent adhesive so that the first layer 20 and the second layer 30 can be observed. The adhesive layer 60 can be formed by using, for example, PMMA, urethane, silicone, or the like. It is desirable that the layer thickness of the adhesive layer 60 is set to 0.5 μm or more and 50 μm or less. This is because if the layer thickness of the adhesive layer 60 is less than 0.5 μm, uniform processing is difficult and asperities of the base cannot be absorbed. Further, this is because if the layer thickness of the adhesive layer 60 is larger than 50 μm, it takes much time and labor to remove the solvent during the thick coating processing, and the cost increases accordingly.

The protective layer 70 is a layer for protecting the first layer 20 and the second layer 30, and is stuck onto the second layer 30 via the adhesive layer 60. The protective layer 70 has a resin base material layer 71 and a surface layer 72.

The resin base material layer 71 has an adhesive layer 60 laminated on one surface thereof, and a surface layer 72 laminated on the other surface thereof. The resin base material layer 71 includes a transparent resin so that the first layer 20 and the second layer 30 can be observed. In the present embodiment, it is assumed that the marker 1 is used under visible light, and the adhesive layer 60 and the resin base material layer 71 are configured to be transparent to white light. Specifically, it is desirable that the adhesive layer 60 and the resin base material layer 71 each have a total light transmittance of 50% or more in a region where the wavelength of light is 400 nm to 700 nm. More desirably, the total light transmittance in the region where the wavelength of light is 400 nm to 700 nm is 50% or more in a state where the adhesive layer 60 and the resin base material layer 71 are measured together. It is desirable that the layer thickness of the resin base material layer 71 is set to 7 μm or more and 250 μm or less. This is because if the layer thickness of the resin base material layer 71 is less than 7 μm, lamination processing may be difficult. Further, this is also because if the layer thickness of the resin base material layer 71 is larger than 250 μm, the bulk and weight thereof may become too large, and the cost may increase accordingly. Further, it is preferable that the refractive index of the resin base material layer 71 is 1.45 or more and 1.55 or less.

The surface layer 72 is a layer having both an antireflection function and a hard coat function. In order to prevent the visibility of the marks 2 and the moire display regions 3 and 4 from being deteriorated due to the reflection on the surface of the marker 1, it is desirable that the surface layer 72 has a reflectance of 1.5% or less for light having a wavelength of 535 nm. Further, as the hard coat function of the surface layer 72, it is desirable that the hardness is equal to 1H or higher on a pencil-hardness basis. The surface layer 72 can be configured by using, for example, sol-gel, siloxane, polysilazane, or the like. Examples of a specific method for the antireflection function include antireflection (AR) and antiglare method (AG), but the AR method is preferable for recognition of the mark 2 under a condition that strong light rays such as sunlight are not specularly reflected. Under a condition that strong light rays such as sunlight may be specularly reflected, the AG method is preferable for recognition of the mark 2. The AR method can be created by a known method such as multi-layer thin film interference or a moth-eye method. The AG method may be created by a known method such as a method of kneading light-diffusing particles for making the surface of a film to have asperities into a film or coating the same onto the surface of a film.

The adhesive layer 60 is filled and exists in the first non-display regions 22 described above. However, the second pattern 43 of the third layer 40 can be seen through the first non-display regions 22 since the adhesive layer 60 and the protective layer 70 are transparent and the base material layer 10 which is made of glass is transparent. Accordingly, when the marker 1 is observed from the surface side thereof, the first pattern 23 and the second pattern 43 are seen while overlapping each other, and the moire M can be observed.

Further, it is desirable as a characteristic of the combination of the adhesive layer 60 and the protective layer 70 that the total light transmittance is 85% or more. This is because if the total light transmittance is less than 85%, a sufficient light amount may not be secured. Further, it is desirable as a characteristic of the combination of the adhesive layer 60 and the light diffusion layer 70 that the haze value is 30% or more, more preferably 40% or more, and yet more preferably 70% or more. This is because: if the haze value is lower than 70%, the effect of the present invention may begin to deteriorate; if the haze value is equal to or less than 40%, the effect may further deteriorate; and if the haze value is equal to or less than 30%, the effect may significantly deteriorate. On the other hand, it is desirable that the haze value is equal to or less than 95%. This is because if the haze value is higher than 95%, the image of the observed mark may blur.

Conventionally, as described in Patent Document 1 (U.S. Pat. No. 8,625,107), when a plurality of patterns are displayed overlapped with each other to generate moire, light is blocked by a pattern arranged on the observation side, so that the whole is observed darkly. Even when moire occurs under a dark environment, the moire is unclear, and it may be difficult to identify the position of the moire by photographing the moire with a camera. Therefore, in the present embodiment, the moire can be observed more clearly by improving the first pattern 23 and the second pattern 43.

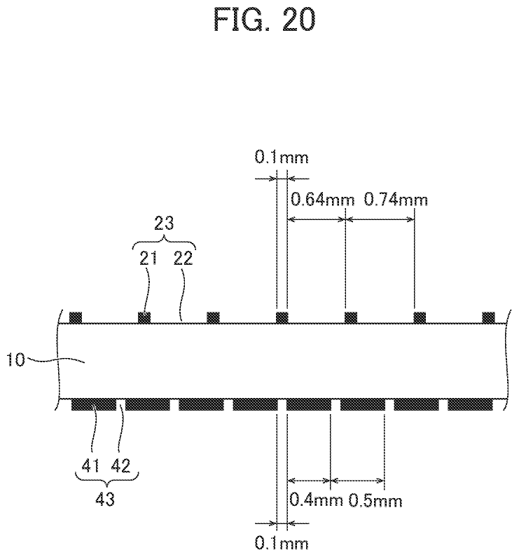

FIG. 20 is a diagram showing the details of the first pattern 23 and the second pattern 43. FIG. 20 shows a cross section similar to that of FIG. 18, but only three layers of the base material layer 10, the first layer 20, and the third layer 40 are shown. In the present embodiment, the width of the first non-display region 22 and the width of the second non-display region 42 are different from each other. Specifically, in the present embodiment, the width of the first non-display region 22 is set to 0.64 mm, and the width of the second non-display region 42 is set to 0.1 mm. Since the first non-display regions 22 are arranged on the observation side (front surface side), and the width of the first non-display regions 22 is larger than the width of the second non-display regions 42, so that a large amount of light passes through the first pattern 23 and reaches the second pattern 43, and most of light reflected off the second pattern 43 and returned to the observation side can pass through the first pattern 23 and reach the observation position. Therefore, the moire M can be observed more brightly.

Further, the width of the first display lines 21 and the width of the second display lines 41 are different from each other. This makes it possible to observe the moire M more clearly as compared with a case where both the widths are equal to each other. Specifically, the width of a first display line 21 is set to 0.1 mm, and the width of a second display line 41 is set to 0.4 mm. The width of the first display line 21 is made narrower than the width of the second display line 41 as described above, so that a larger amount of light passes through the first pattern 23, and the moire M can be observed more brightly.

A first pitch which is the arrangement pitch of the first display lines 21 is set to 0.74 mm, and a second pitch which is the arrangement pitch of the second display lines 41 is set to 0.5 mm, thereby making both the pitches different from each other. As a result, the moire M can be observed more clearly. Since the first pitch is set to be larger than the second pitch, as a result, the width of the first non-display regions 22 is larger than the width of the second non-display regions 42, so that the moire M can be observed more brightly.

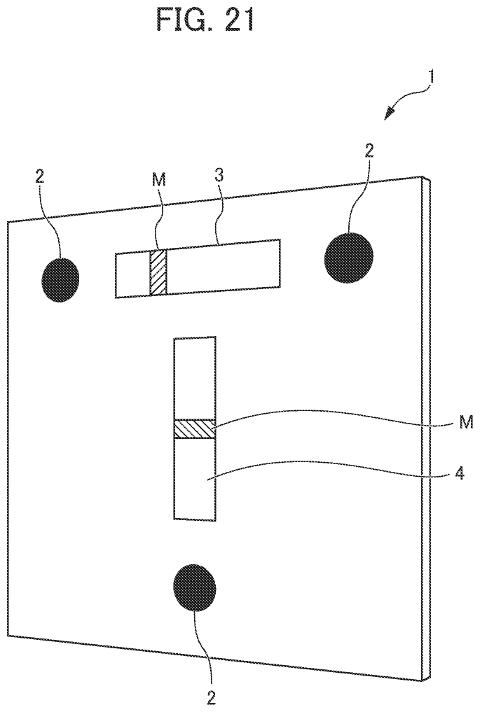

Next, an example of a way of using the marker 1 of the present embodiment will be described. FIG. 21 is a diagram showing a state of the marker 1 when the marker 1 is viewed in a diagonal direction. FIG. 21 shows a state in which the marker 1 is observed in a diagonal direction indicated by an arrow B in FIG. 18, but is observed without being tilted with respect to an up-and-down direction in FIG. 17. When the marker 1 is observed in a diagonal direction which is inclined from the normal direction thereof, for example, as shown in FIG. 21, the moire M in the moire display region 3 is observed as having shifted in the longitudinal direction of the moire display region 3. When the marker 1 is observed in the up-and-down diagonal direction which is inclined in the longitudinal direction of the moire display region 4 from the normal direction thereof, the moire M of the moire display region 4 is observed as having shifted in the longitudinal direction of the moire display region 4. Therefore, by observing both the moire M in the moire display region 3 and the moire M in the moire display region 4, the relative position (inclination angle) between the marker 1 and the observation position can be accurately detected. In other words, the marker 1 can configure a part of an angle sensor by using the marker 1 in combination with an imaging unit and a calculation unit.

Here, when the moire M shifts to a position where the observation position is greatly deviated from the normal direction of the marker 1, it causes another moire to be observed, and moire is observed one after another. Therefore, when the observation position is located at a position which is significantly deviated from the normal direction of the marker 1, it may be impossible to perform correct position detection. However, the marker 1 of the present embodiment includes the marks 2. In the position detection using the marks 2, the position detection can be performed even when the observation position greatly deviates from the normal direction of the marker 1. On the other hand, the position detection using the moire display regions 3 and 4 can be performed with higher accuracy than the position detection based on the marks 2. Accordingly, by using both the position detection with the marks 2 and the position detection with the moire display regions 3 and 4, the applicable range can be expanded as compared with the case where only the moire display regions 3 and 4 are used. In other words, even when the observation position is located at a position which deviates greatly from the normal direction of the marker 1, it is possible to perform the position detection using marks 2 and automatically shift the observation position according to a detection result, such that it is possible to perform the position detection using the moire display regions 3 and 4 at a stage where final highly-accurate position control is required.

As described above, according to the marker 1 of the present embodiment, since the width of the first non-display regions 22 is larger than the width of the second non-display regions 42, a larger amount of light can be taken into the moire display regions 3 and 4, and a larger amount of light can be returned to the observation side, so that the moire M can be displayed more brightly. Therefore, even when the moire M displayed in the moire display regions 3 and 4 is photographed by a camera or the like, the position thereof can be acquired more accurately, and highly accurate position detection can be implemented accordingly.

### Fifth Embodiment

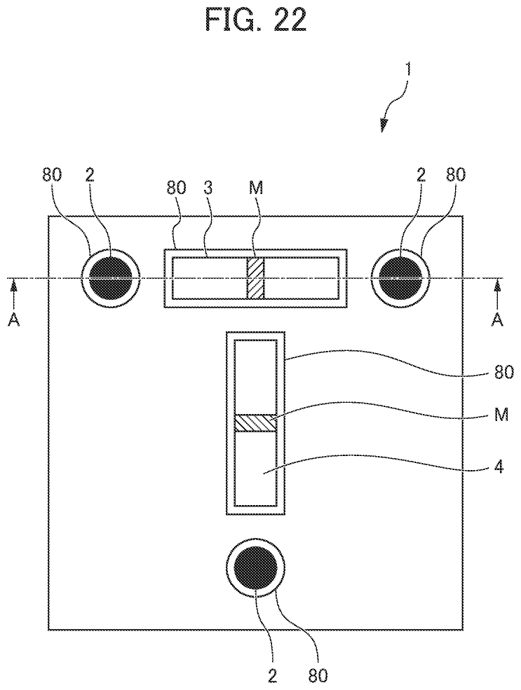

FIG. 22 is a diagram showing a fifth embodiment of the marker according to the present invention. The following figures including FIG. 22 are schematic diagrams, and the sizes and shapes of respective parts are presented by being exaggerated or omitted as appropriate to facilitate understanding thereof. Further, the following description will be made while presenting specific numerical values, shapes, materials, and the like, but these can be changed on an as-needed basis. In the present specification, terms such as plate, sheet, and film are used. The terms of plate, sheet, and film are generally used in the decreasing order of thickness, and these terms are also used in the same way in the present specification. However, such a manner of use has no technical meaning, and thus these terms may be replaced on an as-needed basis. Further, in the present invention, a “transparent” substance means a substance which transmits therethrough light having at least a wavelength to be used. For example, if a substance transmits infrared rays although it does not transmit visible light, the substance shall be treated as a transparent substance when used for applications using infrared rays. It should be noted that specific numerical values specified in the present specification and the claims should be treated as including a general error range. In other words, a difference of about ±10% is substantially the same, and a value set in a range slightly beyond the numerical range of the present invention should be interpreted as being substantially within the numerical range of the present invention.

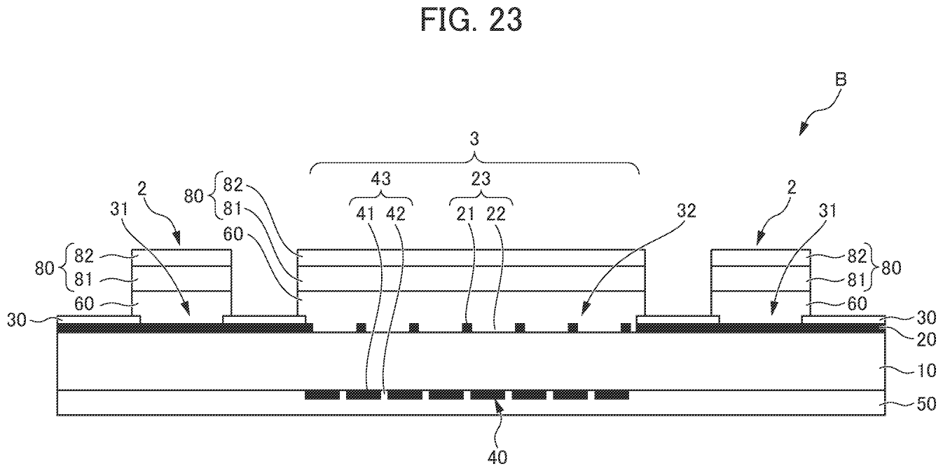

As shown in FIG. 22, a marker 1 is configured like a plate having a substantially square shape when viewed from a normal direction of the surface on which a light diffusion layer 80 described later is provided, and includes marks 2, and moire display regions 3 and 4. In the present embodiment, the marker 1 is formed so that the shape thereof when viewed from the surface side is a square shape of 60 mm×60 mm. The marker 1 detects the relative positional relationship between a photographing position and the marker 1 according to how the marks 2 are observed (hereinafter, also simply referred to as position detection), and further, the position detection can be performed with higher accuracy according to how moire displayed in the moire display regions 3 and 4 is observed. In the marker 1, a surface shown in FIG. 22 is a front side (front surface) to be observed, an opposite side thereto is a back side (back surface). In FIG. 23 described later, a side on which the light diffusion layer 80 is provided is a front side (front surface) to be observed.

The marks 2 are arranged at two places near two upper corners in FIG. 22 and one place near the lower right-and-left center, that is, totally three marks are arranged to be spaced from one another. Each mark 2 is configured to be observable as a mark having an independent shape. Note that a mark having an independent shape means that a plurality of marks are not connected and each of the marks has an individually recognizable form. It is desirable that at least three marks 2 are arranged. This is because, for example, if the positions of the centers of gravity of the marks 2 are calculated at three points from an observation result of the marks 2, the relative position and inclination between the observation position (camera or the like) and the marker 1 can be accurately detected. Further, if the number of marks 2 is larger than 3, for example, when some marks 2 are unclearly observed due to some kind of obstacle, the position detection can be performed from an observation result of the remaining marks 2. By using a plurality of marks 2, the accuracy of position detection can be improved. In the present embodiment, each mark 2 is configured in a circular shape, but the mark 2 is not limited to the circular shape, and may be a polygonal shape such as a triangle or a quadrangle, or another shape.

The moire display regions 3 and 4 display moires M. FIG. 22 shows a state in which the moires M are displayed in the centers of the moire display regions 3 and 4 in both the moire display regions 3 and 4. The position where a moire M is displayed shifts when the relative position (angle) between the marker 1 and the observation position changes. In the present embodiment, each of the moire display regions 3 and 4 has a length of 30 mm in the longitudinal direction, and the display position of the moire M shifts along the longitudinal direction. The moire display region 3 and the moire display region 4 are arranged so that their longitudinal directions are orthogonal to each other. Since the moire display regions 3 and 4 have the same configuration except that the arrangement directions thereof are different from each other, the moire display region 3 will be described below.

FIG. 23 is a cross-sectional view of a marker which is cut at the position of arrows A-A in FIG. 22. The marker 1 which is configured like a thin plate includes a base material layer 10, a first layer 20, a second layer 30, a third layer 40, a reflective layer 50, an adhesive layer 60 and a light diffusion layer 80. The laminating order of these layers is an order of the reflective layer 50, the third layer 40, the base material layer 10, the first layer 20, the second layer 30, the adhesive layer 60, and the light diffusion layer 80 from the back surface side.

The base material layer 10 includes a glass plate. By forming the base material layer 10 of a glass plate, it is possible to prevent the marker 1 from expanding and contracting due to temperature change and moisture absorption. The linear expansion coefficient of the glass plate is, for example, about 31.7×10⁻⁷/° C., and the dimensional change caused by the temperature change is very small. The glass plate of the base material layer used in the present embodiment is Corning® EAGLE XG®, which has a linear expansion coefficient of 3.17×10⁻⁶/° C. Measurement of the linear expansion coefficient of the glass plate used for the base material layer 10 is based on JIS R3102. Further, the linear expansion coefficient of ceramics is, for example, about 28×10⁻⁷/° C., and the dimensional change caused by the temperature change is very small like glass. Therefore, ceramics may be used alternatively for the base material layer. In order to suppress the dimensional change caused by the temperature change, it is desirable that the base material layer 10 has a linear expansion coefficient of 35×10⁻⁶/° C. or less. Examples of ceramics to be used for the base material layer include silicon nitride (with a linear expansion coefficient of 2.8×10⁻⁶/° C.). Specifically, the examples include DENKA SN PLATE (manufactured by Denka Company Limited). Further, other examples to be used for the base material layer include an alumina substrate (96% alumina (manufactured by Nikko Company)), an alumina zirconia substrate (manufactured by MARUWA Co., Ltd.), and an aluminum nitride substrate (manufactured by MARUWA Co., Ltd.). In the case of ceramics, measurement of the linear expansion coefficient is based on JIS R1618. It is desirable that the layer thickness of the base material layer 10 is set to 0.3 mm or more and 2.3 mm or less. This is because if the layer thickness of the base material layer 10 is less than 0.3 mm, additional machining may not be performed because the base material layer 10 may crack during the cutting processing, and if the layer thickness is larger than 2.3 mm, the weight may be too large, and may not be transported. The layer thickness of the base material layer 10 of the present embodiment is set to 0.7 mm.

The first layer 20 is formed of a resist material colored black (first color). The resist material constituting the first layer 20 of the present embodiment is a resist material which has lost photosensitivity as a result of performing developing processing on a resist material having photosensitivity to be used in the photolithography step. Examples of the resist material to be used for the first layer 20 (in the case of black color) include PMMA (Poly Methyl Methacrylate), ETA (eicosatetraenoic acid), HETA (hydroxyeicosatetraenoic acid), HEMA (2-Hydroxyethyl methacrylate), or a mixture with epoxy, etc. Examples of the material to be colored black include carbon, titanium blackened, nickel oxide, and the like. In the present embodiment, since the first layer 20 is formed of the resist material, the surface of the first layer 20 can be formed very smoothly, which makes the first layer 20 desirable as a base for forming the second layer 30 described later. Further, since the first layer 20 is formed of the resist material, a first pattern 23 described below can be manufactured accurately and easily. It is desirable that the layer thickness of the first layer 20 (in the case of black) is set to 1 μm or more and 5 μm or less. This is because if the layer thickness of the first layer 20 is 1 μm or less, it may not be uniformly formed, and if the layer thickness of the first layer 20 is greater than 5 μm, the curing reactivity of the resin by ultraviolet rays may be insufficient.

The first layer 20 constitutes a portion of the mark 2 that appears black. Further, the first layer 20 constitutes a first pattern 23 for displaying a moire in the moire display region 3. The first pattern 23 is arranged in a region serving as the moire display region 3 on one surface (on the front surface) of the base material layer 10. In the first pattern 23, first display lines 21 are arranged at equal intervals in a constant arrangement direction in the longitudinal direction of the moire display region 3. A portion which is located between an adjacent pair of first display lines 21 and in which no first display line 21 is provided is a first non-display region 22, and the first display lines 21 and first non-display regions 22 are alternately arranged. The first pattern 23 is formed by photolithography processing.

The second layer 30 is formed of a resist material colored white (second color). The resist material constituting the second layer 30 of the present embodiment is a resist material which has lost photosensitivity as a result of performing developing processing on a resist material having photosensitivity to be used in the photolithography step. Examples of the resist material to be used for the second layer 30 (in the case of white color) include PMMA, ETA, HETA, HEMA, a mixture with epoxy, and the like. Examples of the material to be colored white include titanium oxide, zirconia, barium titanate, and the like. The second layer 30 has opening portions 31 formed at three locations at which the portions corresponding to the marks 2 are opened to visualize the first layer 20, and has opening portions 32 formed at two locations at which the portions corresponding to the moire display regions 3 and 4 are opened to visualize the first layer 20 and the third layer 40. These opening portions 31 and the opening portions 32 are formed by photolithography processing.

It is desirable that the layer thickness of the second layer 30 is set to 3 μm or more and 100 μm or less. This is because if the layer thickness of the second layer 30 is smaller than 3 μm, the first layer 20 of the base may be observed to be seen through the second layer 30, the contrast is lowered, and the visibility of the mark 2 (easiness of detection by automatic recognition) may deteriorate accordingly. Further, this is because if the layer thickness of the second layer 30 is larger than 100 μm, in the case of observing the mark 2 in a diagonal direction, a region may increase where the first layer 20 is shaded by the second layer 30 and cannot be seen at the peripheral edge portion of the opening portion 31, so that the distortion of the observed shape of the mark 2 may increase.

The third layer 40 is formed of a resist material colored black (first color). The third layer 40 of the present embodiment includes the same material as the first layer 20, and a preferable film thickness is also the same as that of the first layer 20. Since the third layer 40 is formed of the resist material, a second pattern 43 described below can be accurately and easily manufactured.

The third layer 40 is provided with a second pattern 43 for displaying a moire in the moire display region 3. The second pattern 43 is arranged to face the first pattern 23 in a region serving as the moire display region 3 on the back surface of the base material layer 10. In the present embodiment, the first pattern 23 is provided on one surface of the base material layer 10, and the second pattern 43 is provided on the other surface. However, the first pattern 23 and the second pattern 43 may be configured so that they are provided on different base materials or the like, and then bonded to each other. In the second pattern 43, second display lines 41 are arranged at equal intervals in a constant arrangement direction in the longitudinal direction of the moire display region 3. A portion which is located between an adjacent pair of second display lines 41 and in which no second display line 41 is provided is a second non-display region 42, and the second display lines 41 and second non-display regions 42 are alternately arranged. The second pattern 43 is formed by photolithography processing.

The reflective layer 50 is a layer for reflecting light arriving from the front side (observation side) of the marker 1 through the opening portion 32 toward the front side. It is desirable that the reflective layer 50 can be configured by using, for example, PMMA, ETA, HETA, HEMA, or a mixture with epoxy, and the like and the reflective layer 50 is white in order to enhance the contrast to the first display lines 21 and the second display lines 41. Examples of the material to be colored white include titanium oxide, zirconia, barium titanate, and the like.

Here, the reflective layer 50 may be configured to be laminated in close contact with the marker 1 so as to be integrated with the marker 1 as in the present embodiment, and may be configured alternatively such that a reflective member or the like as another member is arranged on the back surface side of the marker 1. However, from the viewpoint of enabling the moire M to be seen more easily, the configuration of the present embodiment in which the reflective layer 50 is laminated and arranged in close contact with the marker 1 so as to be integrated with the marker 1 is more desirable. The reason for this will be described below.

The moire M which is essentially desired to be observed is a moire to be observed due to interference between the first display lines 21 and the second display lines 41. However, an unnecessary moire (extra noise image) occurs due to only the first display lines 21 and only the second display lines 41 under some conditions. It is considered that when an unnecessary moire of the second display lines 41 occurred by light which scatters at end surface portions of the second display lines 41, that is, at end surface portions of the second display lines 41 existing on the second non-display region 42 side and returns to the observer side, the unnecessary moire interferes with the moire M which is essentially desired to be seen and accordingly disturbs the observation of this moire M. Therefore, the reflective layer 50 is provided so as to fill the second non-display regions 42, whereby the above phenomenon can be avoided and the moire M can be observed more clearly. For the above reason, the reflective layer 50 may be provided at least in the second non-display regions 42, but as shown in FIG. 23, it is desirable that the reflective layer 50 is provided so as to cover the back surface sides of the second display lines 41. The reason for this resides in that the bounce of light from the edge portions on the back surface sides of the second display lines 41 is suppressed, and the main component of periodic bounce light can be eliminated.

The adhesive layer 60 is a layer of an adhesive for sticking the light diffusion layer 80 onto the second layer 30. The adhesive layer 60 can be formed by using, for example, PMMA, urethane, silicone, or the like. It is desirable that the layer thickness of the adhesive layer 60 is set to 0.5 μm or more and 50 μm or less. This is because if the layer thickness of the adhesive layer 60 is less than 0.5 μm, uniform processing may be difficult and asperities of the base may not be absorbed. Further, this is because if the layer thickness of the adhesive layer 60 is larger than 50 μm, it may take much time and labor to remove the solvent during the thick coating processing, and the cost may increase accordingly. Further, the adhesive layer 60 is provided only in the same range as the range in which the light diffusion layer 80 is provided.

The light diffusion layer 80 is provided in an island-like shape on the marks 2 and the moire display regions 3 and 4 via the adhesive layer 60, such that the light diffusion layer 80 covers the marks 2 and the moire display regions 3 and 4 slightly beyond the regions of them. Specifically, the light diffusion layer 80 is provided in an island-like shape in a range which is larger than the mark 2 by 2 to 3 mm on one side (in radius). Similarly, the light diffusion layer 80 is provided in an island-like shape in a range which is larger than each of the moire display regions 3 and 4 by 2 to 3 mm on one side (in extended width on one side). The light diffusion layer 80 is provided in an island-like shape but not provided in other portions, which makes it possible to easily provide the light diffusion layer later if necessary. Further, such an island-like shape can prevent in advance the light from propagating to another island-shaped light diffusion layer 80 with a resin base material layer 81 serving as a light guide and accordingly affecting the other island if the light diffusion layer 80 (including the resin base material layer 81) is continuous, when strong light such as sunlight is incident to only one island-shaped light diffusion layer 80. The light diffusion layer 80 has a resin base material layer 81 and a surface layer 82.

The resin base material layer 81 has an adhesive layer 60 laminated on one surface thereof, and a surface layer 82 laminated on the other surface thereof. The resin base material layer 81 includes a transparent resin so that the first layer 20 and the second layer 30 can be observed. In the present embodiment, it is assumed that the marker 1 is used under visible light, and the adhesive layer 60 and the resin base material layer 81 are configured to be transparent to white light. Specifically, it is desirable that the adhesive layer 60 and the resin base material layer 81 each have a total light transmittance of 50% or more in a region where the wavelength of light is 400 nm to 700 nm. More desirably, the total light transmittance in the region where the wavelength of light is 400 nm to 700 nm is 50% or more in the state where the adhesive layer 60 and the resin base material layer 81 are measured together. It is desirable that the layer thickness of the resin base material layer 81 is set to 7 μm or more and 250 μm or less. This is because if the layer thickness of the resin base material layer 81 is less than 7 μm, lamination processing may be difficult. Further, this is also because if the layer thickness of the resin base material layer 81 is larger than 250 μm, the bulk and weight thereof may become too large, and the cost may increase accordingly. Further, it is preferable that the refractive index of the resin base material layer 81 is 1.45 or more and 1.55 or less.

The surface layer 82 is a layer that exerts light diffusion. The surface layer 82 of the present embodiment has micro asperities on the surface thereof, and constitutes a so-called matte surface (rough surface). The surface layer 82 diffuses light reflected off a surface by means of the micro asperities. Here, various antireflection layers to be applied to antiglare films can be applied to the surface layer 82 having such micro asperities. For example, the surface layer 82 may be prepared by embossing, may be prepared with the surface thereof being made as a rough surface by mixing translucent fine particles, may be prepared with the surface thereof being made as a rough surface (so-called chemical matte surface) by solving the surface with a chemical agent, or may be prepared by shaping processing using a shaping resin layer.

Further, the surface layer 82 has a hard coat function. Further, as a hard coat function of the surface layer 82, it is desirable that the hardness is equal to 1H or higher on a pencil hardness basis. By providing the surface layer 82 with a hard coat function, the light diffusion layer 80 can also have a function as a protective layer. Further, it is desirable that the surface layer 82 has a regular reflectance of 1.5% or less for light having a wavelength of 535 nm in order to prevent deterioration in visibility of the mark 2 and the moire display regions 3 and 4 due to the reflection at the surface of the marker 1.

Further, it is desirable as a characteristic of the composition of the adhesive layer 60 and the light diffusion layer 80 that the total light transmittance is 85% or more. This is because if the total light transmittance is less than 85%, a sufficient light amount may not be secured. Further, it is desirable as a characteristic of the combination of the adhesive layer 60 and the light diffusion layer 80 that the haze value is 30% or more, more preferably 40% or more, and yet more preferably 70% or more. This is because if the haze value is lower than 70%, the effect of the present invention may begin to deteriorate, if the haze value is equal to or less than 40%, the effect may further deteriorate, and if the haze value is equal to or less than 30%, the effect may significantly deteriorate. On the other hand, it is desirable that the haze value is equal to or less than 95%. This is because if the haze value is higher than 95%, the image of the observed mark may blur.

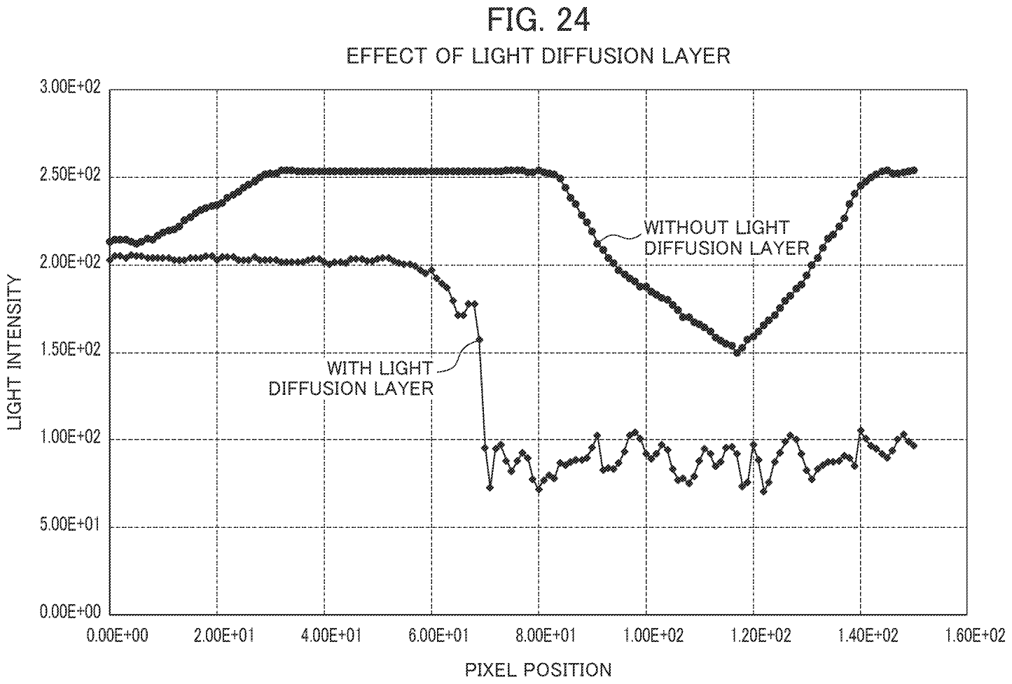

FIG. 24 is a graph showing the effect of the light diffusion layer 80. In order to confirm the effect obtained by providing the light diffusion layer 80, two types of markers were actually created with and without the light diffusion layer 80. The two types of markers are photographed when illuminated so that reflected light is strongly returned to the camera with respect to the positions of the marks 2 of the two types of the markers. And the change in light intensity in the neighborhood of a white-and-black reversed site of the mark 2 depending on the position of the mark is quantified, which is shown in FIG. 24. As shown in FIG. 24, when the light diffusion layer 80 is not provided, the reflection of the illumination light appears as a waveform as is, and the waveform corresponding to the shape of the mark 2 was not observed. The light intensity without light diffusion layer 80 is too strong, and exceeds a measurement limit (2.50E+02). On the other hand, when the light diffusion layer 80 was provided, recognizable data was obtained by appropriately separating the light intensity of a white portion and the light intensity of a black portion from each other according to the position of the mark 2. When the light diffusion layer 80 was measured with a haze meter “HM-150” manufactured by Murakami Color Research Institute based on JIS K7136, the total light transmittance was equal to 90.3%, and the haze value was equal to 75.1%. As can be seen from FIG. 24, when the light diffusion layer is arranged so as to straddle across the mark and its peripheral portion, the shape (outline) of the mark can be clearly captured by the camera. When the light diffusion layer is placed only on the mark with the same shape and size as the mark, the resin base material layer portion of the light diffusion layer acts as a light guide plate, so that light is emitted from the end portion of the resin base material layer, which causes a problem that the shape (outline) of the mark is unclear.

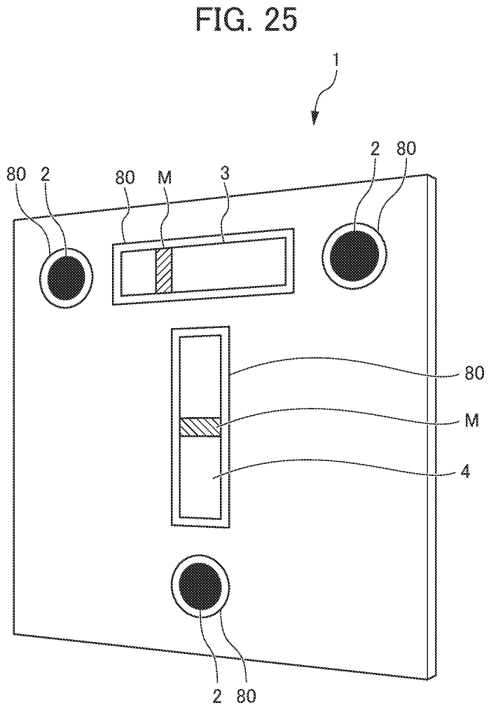

Next, an example of a way of using the marker 1 of the present embodiment will be described. FIG. 25 is a diagram showing a state of the marker 1 when the marker 1 is viewed in a diagonal direction. FIG. 25 shows a state in which the marker 1 is observed in the diagonal direction indicated by the arrow B in FIG. 23, but it is observed without being tilted in the up-and-down direction in FIG. 22. When the marker 1 is observed in a diagonal direction which is inclined from the normal direction thereof, for example, as shown in FIG. 25, the moire M of the moire display region 3 is observed by being shifted in the longitudinal direction of the moire display region 3. When the marker 1 is observed in the up-and-down diagonal direction which is inclined in the longitudinal direction of the moire display region 4 from the normal direction thereof, the moire M of the moire display region 4 is observed as having shifted in the longitudinal direction of the moire display region 4. Therefore, by observing both the moire M in the moire display region 3 and the moire M in the moire display region 4, the relative position (inclination angle) between the marker 1 and the observation position can be accurately detected. In other words, the marker 1 can configure a part of an angle sensor by using the marker 1 in combination with an imaging unit and a calculation unit.

Here, when the moire M shifts to a position where the observation position is greatly deviated from the normal direction of the marker 1, it causes another moire to be observed, and moire is observed one after another. Therefore, when the observation position is located at a position which is significantly deviated from the normal direction of the marker 1, it may be impossible to perform correct position detection. However, the marker 1 of the present embodiment includes the marks 2. In the position detection using the marks 2, the position detection can be performed even when the observation position greatly deviates from the normal direction of the marker 1. On the other hand, the position detection using the moire display regions 3 and 4 allows detection with higher accuracy than the position detection based on the marks 2. Therefore, by using both the position detection using the marks 2 and the position detection using the moire display regions 3 and 4, the applicable range can be expanded as compared with the case where only the moire display regions 3 and 4 are used. In other words, even when the observation position is located at a position which deviates greatly from the normal direction of the marker 1, it is possible to perform the position detection using marks 2 and automatically shift the observation position according to a detection result, such that it is possible to perform the position detection using the moire display regions 3 and 4 at a stage where final highly-accurate position control is required.

As described above, it is assumed that the relative position between the observation position and the marker 1 is set to have various positional relationships. Accordingly, the relative position may have such a positional relationship that illumination light, sunlight, or the like is specularly reflected to the observation position. Even in such a case, since the marker 1 of the present embodiment has the light diffusion layer 80, the reflected light can be appropriately diffused. As a result, it is possible to increase situations where the marks 2 of the marker and the moire display regions 3 and 4 are observable.

As described above, according to the marker 1 of the present embodiment, it is possible to improve the situation where it is difficult to recognize an index or the like indicated by the marker 1 due to illumination light or the sunlight, and provide a marker which is easy to recognize even in such an environment where the sunlight, illumination light or the like hits the marker.

### Sixth Embodiment

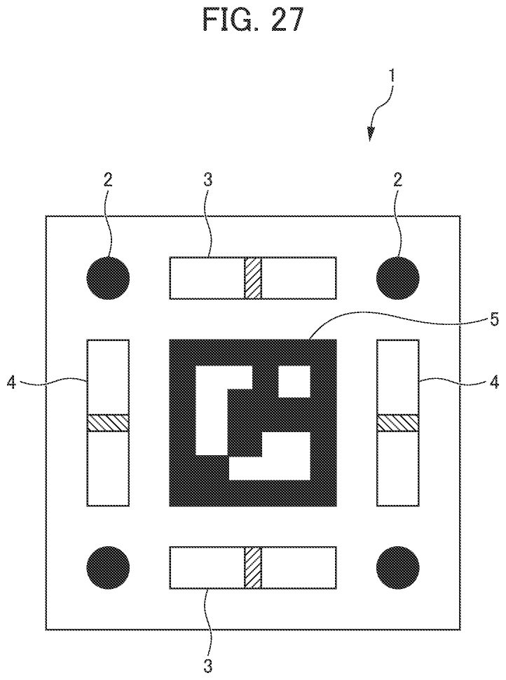

FIG. 27 is a diagram showing a sixth embodiment of a marker according to the present invention. A marker 1 of the sixth embodiment includes marks 2, moire display regions 3 and 4, and an identification mark 5. The marker 1 of the sixth embodiment is the same as the other embodiments described above except that the arrangement of the marks 2 and the moire display regions 3 and 4 is different and the identification mark 5 is provided. Therefore, the same reference numerals are given to portions that perform the same functions as those of each embodiment described above, and duplicative description thereon will be omitted on an as-needed basis. The layer configuration of the marker 1 of the sixth embodiment is the same as the marker 1 of the first embodiment, but may have the same configuration as that of the third embodiment.

In the present embodiment, the marks 2 are provided near four corners. The moire display regions 3 are respectively provided in the vicinity of the upper and lower end portions in FIG. 27. The moire display regions 4 are respectively provided in the vicinity of the left and right end portions in FIG. 27. The identification mark 5 is provided in the center of the marker 1. The identification mark 5 is a pattern figure (a figure for identification) that is associated with a specific meaning by a pattern of the mark and indicates unique information by the pattern. For example, the identification mark 5 is associated with a unique number, an alphabet, or the like for each different pattern. As the identification mark 5 may be used a two-dimensional bar code, a three-dimensional bar code, a QR code (registered trademark), ArUco, or the like. As described above, various known identification codes and the like can be used as the identification mark 5. However, the identification mark 5 is configured so that the number of patterns is reduced and the size of the pattern is increased as in the present embodiment, which facilitates detection by the camera.

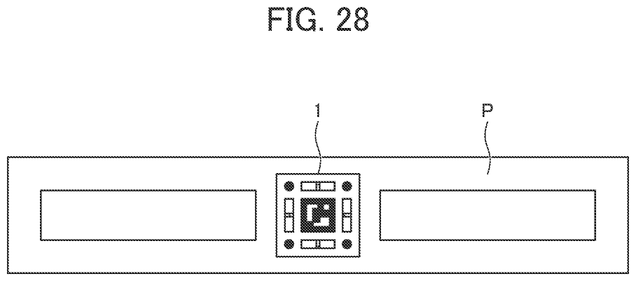

FIG. 28 is a diagram showing a pallet P to which the marker 1 of the sixth embodiment is attached. The marker 1 of the present embodiment is attached to a pallet P to be used, for example, for physical distribution, and can be used to identify the pallet P as a detection target. Therefore, for example, from a result photographed by a camera of an automatic operating forklift, it is possible to accurately grasp the relative positional relationship between the forklift and a pallet and control the operation of the forklift based on the relative positional relationship, and further it is possible to identify pallets P individually. A method of attaching the marker 1 to a detection target may be a method using, for example, an adhesive or glue, or a method of providing a pallet P with an attachment section for detachably attaching the marker 1 thereto.

According to the marker 1 of the present embodiment, since it is provided with the identification mark 5, it can be used not only for position detection as in other embodiments described above, but also for identifying a target to which the marker 1 is attached. Although the marker 1 having the moire display regions 3 and 4 is illustrated in FIGS. 27 and 28, the purpose of the moire display region is to measure the inclination of the marker with high accuracy, and thus the moire display region may be omitted when the measurement accuracy achieved by using the marks 2 alone is sufficient for the purpose. Further, when the marker 1 is attached to the pallet P used for physical distribution, it is preferable that protective layers 70 and 70C are laminated via an adhesive layer 60. For example, even when the claw of a forklift hits the marker 1, the protective layers 70 and 70C function as a scattering prevention layer, so that fragments of a base material layer 10 are prevented from scattering. This is because even when the base material layer 10 cracks, first layers 20 and 20C and second layers 30 and 30C are not damaged and thus can maintain the function as markers.

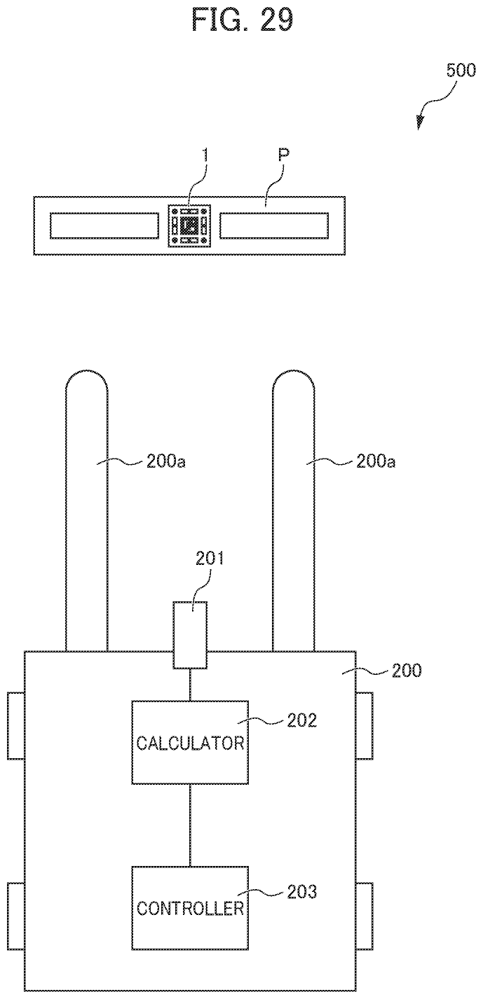

FIG. 29 is a diagram showing a measuring system 500 that includes a marker 1 of the sixth embodiment. The measuring system 500 may use not only the marker 1 of the sixth embodiment, but also the markers 1, 1b, and 1C and the like described in the first embodiment to the sixth embodiment may be used. The measuring system 500 includes a pallet P to which the marker 1 of the sixth embodiment described above is attached, and a forklift 200. The forklift 200 includes a camera (imager) 201, a calculator 202, and a controller 203.

The camera (imager) 201 is provided so as to be capable of photographing an image ahead of the forklift 200, and is provided to photograph the marker 1. The calculator 202 calculates the relative positional relationship between the camera 201 and the marker 1 using images of the marks 2 included in an image of the marker 1 photographed by the camera 201. The calculation method (measuring method) of calculating the dimensions or the pose of the marks 2 using photographed images of the marks 2 performed by the calculator 202 is the method described in Hideyuki Tanaka “Basics and Trends of AR Marker Technologies,” The Journal of the Institute of Electronics, Information and Communication Engineers Vol. 97, No. 8, 2014, pp. 734-740. This technique is also disclosed in the following Internet URL. “Detection of ArUco Markers” [retrieved Jun. 6, 2022], Internet <URL: https://docs.opencv.org/4.x/d5/dae/tutorial_aruco_detection.html>. The description is in a field of “Pose Estimation” on this web page. Assuming the centers of the four marks 2 as the coordinate vectors at the four corners of ArUco Marker, calculation can be easily performed using a function of OpenCV (Open Source Computer Vision Library). In the case of the present embodiment performing control of the forklift 200, the calculator 202 calculates (measures) the relative positional relationship between the camera 201 and the marker 1. Alternatively, another type of calculation (measurement) can be performed. For example, the calculator 202 can perform the following calculation.

### Calculation Example 1

First, the calculator 202 can calculate the relative positional relationship between the camera 201 and the marks 2. The relative positional relationship between the camera 201 and the marks 2 includes not only the dimensions (distances) from the camera 201 to the marks 2, but also the direction in which the front of the marks 2 (marker 1) is oriented, i.e., the posture of the marks (the posture of the marker 1 including the marks 2). Here, the posture of each mark 2 can be represented by, for example, the roll, yaw, and pitch.

### Calculation Example 2

The calculator 202 can calculate the dimensions of an object and the like in the vicinity of the marks 2. For example, the calculator 202 can measure the height of a person standing near the marker 1, where the marks 2 are displayed. Recognition of the person can be automatically performed. This is not limited to a person, but the height of a tree, the size of an animal, etc., the size of a window and the like may be measured, for example.

### Calculation Example 3

The calculator 202 can calculate the dimensions (distances) between designated positions in the vicinity of the marks 2. The position designated in the vicinity of the marks 2 represents a position designated by a user within a range photographed together with the marks 2 on a photographed image taken by the camera 201.

### Calculation Example 4

Further, the calculator 202 can calculate the dimensions (distances) between a plurality of arranged markers 1 (marks 2). In the case where the plurality of markers 1 are arranged, the dimensions (distances) between the arranged marks 2 can be calculated by photographing the plurality of marks 2 in one screen with the camera 201. Further, as described above, the calculator 202 can calculate the relative positional relationship between the camera 201 and the markers 1 (marks 2). Therefore, even when the plurality of arranged markers 1 are separately photographed substantially without moving the position of the camera 201, the dimensions (distances) between the plurality of arranged markers 1 (marks 2) can be calculated. At this time, based on unique information represented by the identification mark 5, each marker 1 can be separately recognized. Accordingly, calculation can be correctly performed.

The controller 203 performs control based on a calculation result of the calculator 202. The control performed by the controller 203 in the present embodiment is integral operation control including upward and downward motions of forks 200a of the forklift 200. The controller 203 preliminarily has information on: the shape and size of the pallet P; and which position on the pallet P the marker 1 is attached to. Accordingly, the controller 203 can grasp the relative positional relationship between the pallet P and the forklift 200, based on the relative positional relationship between the marker 1 and the camera 201 calculated by the calculator 202. The controller 203 can accurately move the forklift 200 to the pallet P as a target, and properly move the forks 200a, by accurately grasping the relative positional relationship which varies moment to moment between the pallet P and the forklift 200. Here, since the identification mark 5 is provided for the marker 1, the individual pallet P can be identified.

The calculator 202 and the controller 203 of the present embodiment are configured by installing a computer program in a computer. More specifically, the calculator 202 and the controller 203 of the present invention are a computer used for controlling the forklift 200 with an application program for a measurement system of the present invention installed therein. The computer used for controlling the forklift 200, may be a general-purpose smartphone or tablet terminal, notebook computer etc., or a computer dedicated specifically to control of the forklift 200. The computer described in the present invention is an information processing apparatus that includes a controller and a storage device.

In the present embodiment, the example where the calculator 202 and the controller 203 are mounted on the forklift 200 is described. Alternatively, for example, the calculator 202 and the controller 203 may be provided in a server or the like installed at a position away from the forklift 200. In this case, pieces of information from a plurality of forklifts 200 are integrated, and the motion of each forklift 200 can be more properly controlled. Alternatively, it may be configured so that the calculator 202 is mounted on the forklift 200, and the controller 203 is provided in a server.

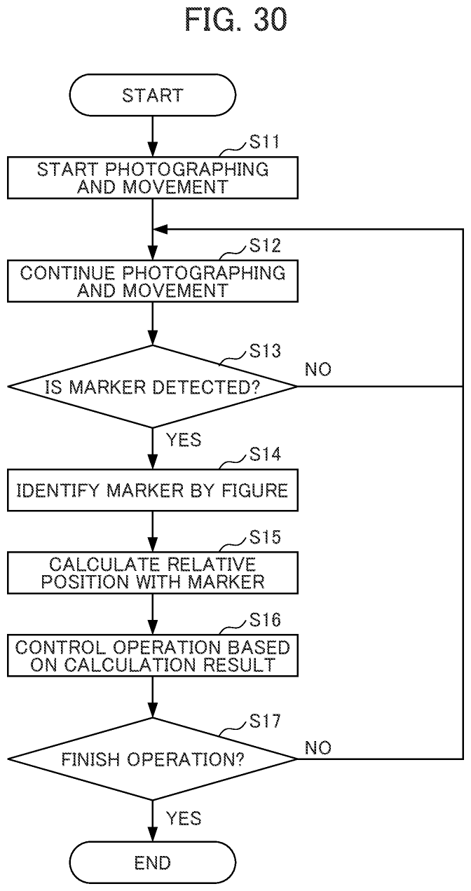

FIG. 30 is a flowchart showing the flow of control operation of the forklift 200 that uses the measuring system 500 of the present embodiment. In step (hereinafter simply represented as S) 11, the controller 203 starts photographing with the camera 201 and moving the forklift 200. In this example, for the sake of simplicity, description is made assuming that the controller 203 starts the operation from a state of grasping the current position of the forklift 200. In S12, the controller 203 continues photographing and moving. In S13, the controller 203 determines whether the marker 1 is detected or not based on an image photographed with the camera 201. If the marker 1 is detected, the processing proceeds to S14. If the marker 1 is not detected, the processing returns to S12, and the operation of detecting the marker 1 is repeated. In S14, the controller 203 identifies on which pallet P the marker 1 is provided, based on the figure (identification mark 5). In 515, the calculator 202 calculates the relative positions of the camera 201 and the marker 1, based on the marks 2 in the image photographed with the camera 201. In 516, the controller 203 controls the operation of the forklift 200, based on a calculation result of the calculator 202. For example, the vertical position of the forks 200a is controlled, and the position of the forklift 200 is controlled. In 517, the controller 203 determines whether the operation is finished or not. If the operation is to be continued, the processing returns to S12. If the operation is not to be continued, the operation is finished. The application program for the measurement system causes the computer to execute each step described above.

As described above, according to the measuring system 500 of the present embodiment, by providing the marker 1 on the pallet P as the measurement target, the relative positional relationship between the pallet P and the forklift 200 can be measured (grasped) at a very high accuracy, and the forklift 200 can be properly controlled accordingly.

### Seventh Embodiment

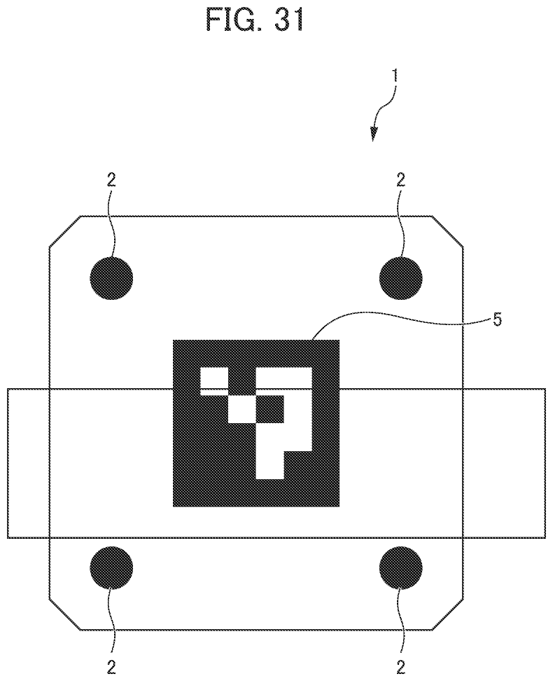

FIG. 31 is a diagram showing a seventh embodiment of a marker according to the present invention. A marker 1 of the seventh embodiment includes marks 2, and an identification mark 5. The marker 1 of the seventh embodiment is the same as that of the sixth embodiment except that moire display regions 3 and 4 are not provided. Therefore, the same reference numerals are given to portions that perform the same functions as those of each embodiment described above, and duplicative description thereon will be omitted on an as-needed basis.

In the seventh embodiment, ArUco is used as the identification mark 5. ArUco is a technique disclosed in the following Internet URL. “Detection of ArUco Markers” [retrieved Mar. 23, 2022], Internet <URL: https://docs.opencv.org/4.x/d5/dae/tutorial_aruco_detection.html>. This web page also describes measurement of the position and posture using ArUco. According to the measurement of the position and posture using ArUco, measurement that is the same as the measurement of the position and posture using the marks 2 described above can be performed. The measurement of the position and posture using the marks 2 can be performed more highly accurately than the measurement of the position and posture using ArUco.

Also in the present embodiment, the position and posture are measured using the marks 2. However, the measurement of the position and posture using the marks 2 may not be accurately performed if the marks 2 are not properly photographed with the camera (imager) 201. For example, if parts of the marks 2 become partially dirty, are blocked by an obstacle, or become unclear due to reflection of light, the position and posture may not be accurately measured.

Accordingly, in the present embodiment, it is configured that in addition to measurement of the position and posture using the marks 2, measurement of the position and posture using the identification mark 5 (ArUco) is also performed in parallel. The measurement operation is described later.

Further, in the present embodiment, the measurement of the position and posture using the identification mark 5 is also performed. Accordingly, the identification mark 5 was configured as the same as the marks 2, and was formed by a photolithography step, in the same manner as that of the marks 2. Accordingly, the accuracy of the measurement of the position and posture using the identification mark 5 can be enhanced. The method of forming the identification mark 5 is the same as that for the marks 2. The identification mark 5 is manufactured at the same time as that of the marks 2. Accordingly, detailed description is omitted. If the user-friendliness has priority over the accuracy, the identification mark 5 may be formed by printing or by sticking a label, seal or the like where the identification mark 5 is separately printed.

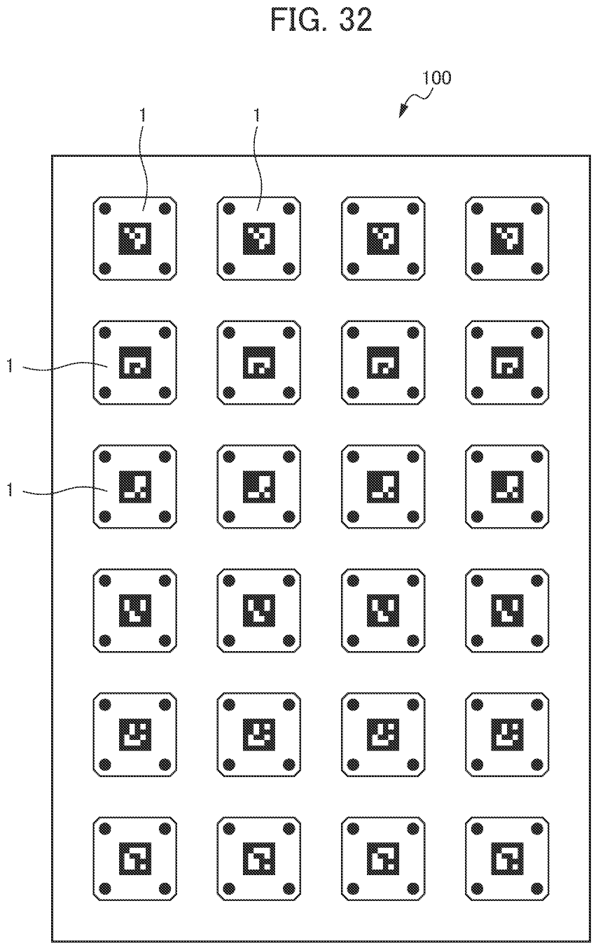

FIG. 32 is a diagram showing a marker multi-imposition body 100 of the seventh embodiment. In the manufacturing of markers 1 of the seventh embodiment, a plurality of markers 1 are manufactured as a marker multi-imposition body 100 in which the plurality of markers 1 are arranged side by side, that is, the plurality of markers 1 are arranged in a multi-imposition manner. Each marker 1 is obtained by cutting out individually to individualize the markers 1 from this marker multi-imposition body 100. On the marker multi-imposition body 100 shown in FIG. 32, on the uppermost row of the markers 1 in the diagram, four ArUco markers with ID=0 are arranged. On the next row, four ArUco markers with ID=1 are arranged. On the next row, four ArUco markers with ID=2 are arranged. On the next row, four ArUco markers with ID=3 are arranged. On the next row, four ArUco markers with ID=4 are arranged. On the next row, four ArUco markers with ID=5 are arranged. That is, the ArUco markers are arranged with their IDs varying on a row-by-row basis. Without any limitation to such arrangement, for example, all the markers 1 on one marker multi-imposition body 100 may be arranged so as to have ArUco (identification mark 5) with the same ID, or all the markers 1 may be arranged so as to have ArUco (identification mark 5) with IDs different from one another.

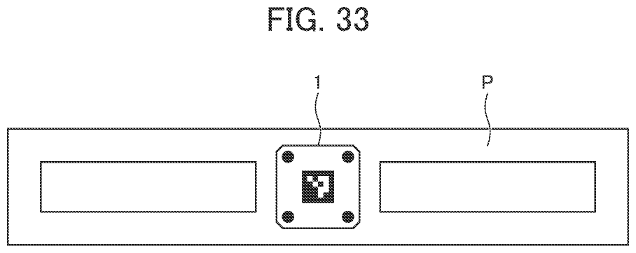

FIG. 33 is a diagram showing a pallet P to which the marker 1 of the seventh embodiment is attached. Similar to the sixth embodiment, the marker 1 of the present embodiment is attached to the pallet P to be used, for example, for physical distribution, and can be used to identify the pallet P as a detection target. The configuration of the pallet P to which the marker 1 of the seventh embodiment is attached is the same as that of the sixth embodiment.

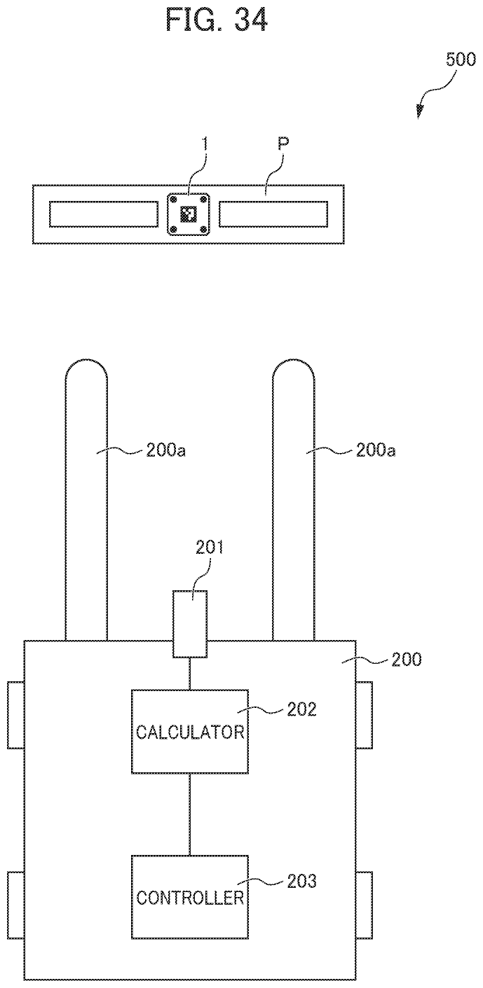

FIG. 34 is a diagram showing a measuring system 500 that includes the marker 1 of the seventh embodiment. The configuration of the measuring system 500 including the marker 1 of the seventh embodiment is the same as the measuring system 500 of the sixth embodiment except that part of the process of the calculator 202 is different. A calculator 202 of the present embodiment can perform calculation that is the same as that in calculation examples 1 to 4 of the sixth embodiment. At this time, in addition to measurement of the position and posture using the marks 2, measurement of the position and posture using the identification mark 5 (ArUco) is also performed in parallel. In a case where measurement of the position and posture using the marks 2 can be properly performed, the calculator 202 outputs a measurement result of the position and posture using the marks 2. On the other hand, in a case where parts of the marks 2 are hidden or the like and thus, are not properly photographed, the calculator 202 outputs a measurement result of the position and posture using the identification mark 5 (ArUco).

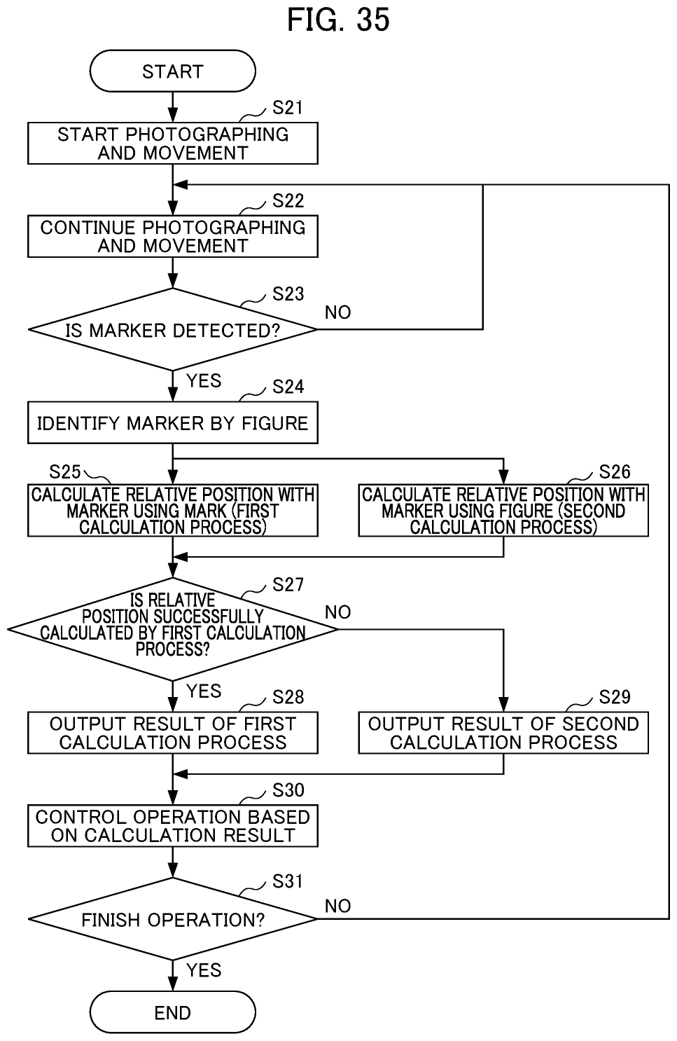

FIG. 35 is a flowchart showing the flow of control operation of the forklift 200 that uses the measuring system 500 of the present embodiment. In S21, the controller 203 starts photographing with the camera 201 and moving the forklift 200. In this example, for the sake of simplicity, description is made assuming that the controller 203 starts the operation from a state of grasping the current position of the forklift 200. In S22, the controller 203 continues photographing and moving. In S23, the controller 203 determines whether the marker 1 is detected or not based on an image photographed with the camera 201. If the marker 1 is detected, the processing proceeds to S24. If the marker 1 is not detected, the processing returns to S22, and the operation of detecting the marker 1 is repeated. In S24, the controller 203 identifies on which pallet P the marker 1 is provided, based on the figure (identification mark 5).

In S25, the calculator 202 performs calculation of relative positions of the marker 1 and the camera 201 (forklift 200) using the marks 2 (hereinafter, a first calculation process). In S26, the calculator 202 performs calculation of relative positions of the marker 1 and the camera 201 (forklift 200) using the figure (identification mark 5) (hereinafter, referred to as “a second calculation process”). The first calculation process in S25 and the second calculation process in S26 are calculation processes performed in parallel. Here, “calculation processes performed in parallel” includes not only a case of processes performed completely in parallel (so-called parallel processing), but also a substantially simultaneous calculation process of performing a second calculation process immediately subsequent to one first calculation process and performing another first calculation process immediately subsequent to the second calculation process. In other words, unlike the form of continuously performing only the first calculation process and normally performing no second calculation process, it is indicated that both the calculation processes are continuously performed. This allows both calculation results of the first calculation process and the second calculation process to be immediately output without any time lag.

In S27, the calculator 202 determines whether the calculation of the relative positions of the marker 1 and the camera 201 (forklift 200) is successfully completed by the first calculation process or not. If the calculation of the relative position is completed, the processing proceeds to S28. If the calculation of the relative position is not completed, the processing proceeds to S29. In S28, the calculator 202 outputs, to the controller 203, the calculation result of the relative positions of the marker 1 and the camera 201 (forklift 200) obtained by the first calculation process. In S29, the calculator 202 outputs, to the controller 203, the calculation result of the relative positions of the marker 1 and the camera 201 (forklift 200) obtained by the second calculation process. In S30, the controller 203 controls the operation of the forklift 200, based on a calculation result of the calculator 202. For example, the vertical position of the forks 200a is controlled, and the position of the forklift 200 is controlled. In S31, the controller 203 determines whether the operation is finished or not. If the operation is to be continued, the processing returns to S22. If the operation is not to be continued, the operation is finished. Each step described above is achieved by the application program for the measurement system causing the computer to execute the steps.

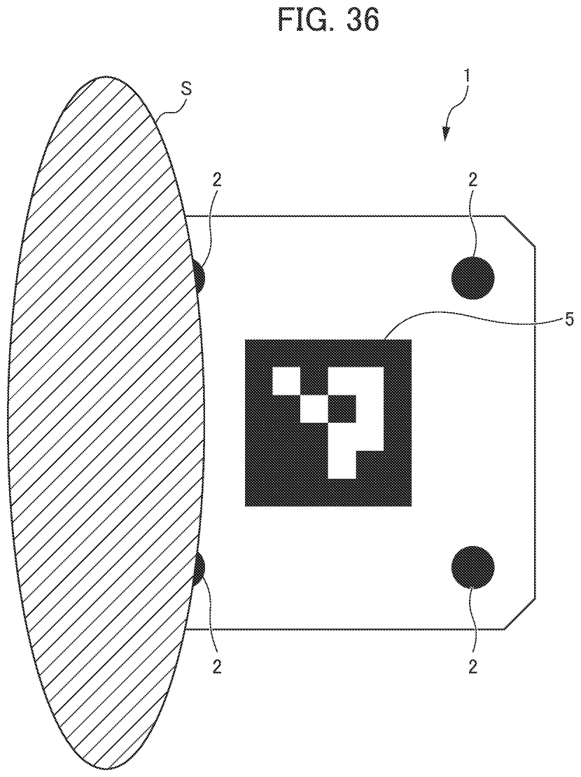

FIG. 36 is a diagram showing a state in which part of the mark 2 is not properly photographed due to an obstacle. For example, if two marks 2 cannot properly be photographed due to the obstacle S as shown in FIG. 36, the calculator 202 cannot perform calculation of the relative positions of the marker 1 and the camera 201 (forklift 200) using the marks 2. In such a case, the flow proceeds to S29, in which the calculator 202 outputs, to the controller 203, the calculation result of the relative positions of the marker 1 and the camera 201 (forklift 200) calculated using the figure (identification mark 5). Accordingly, a situation where calculation cannot be performed, and thus the forklift 200 cannot be controlled can be avoided. If the marks 2 turn out properly photographed because of movement of the obstacle S or the like during subsequent control of the forklift 200, the determination of S27 becomes “YES” and accordingly, the control can be returned to that based on the first calculation process.

As described above, according to the third embodiment, in addition to the measurement of the position and posture using the marks 2 (first calculation process), the measurement of the position and posture using the figure (identification mark 5) is performed in parallel. Consequently, even in the situation where the marks 2 cannot be properly photographed, the measurement of the position and posture can be continuously performed.

### (Modified Forms)

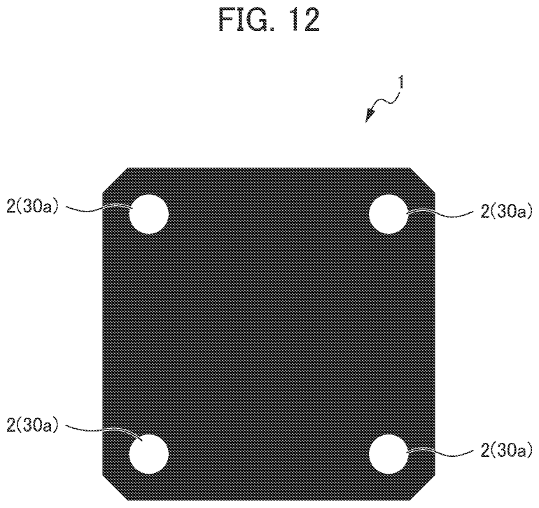

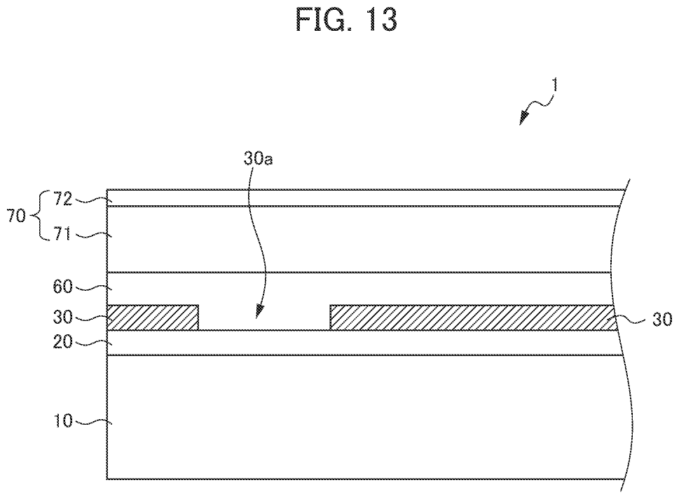

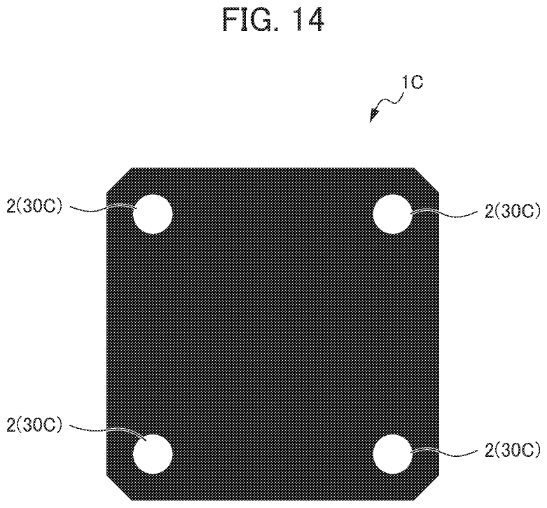

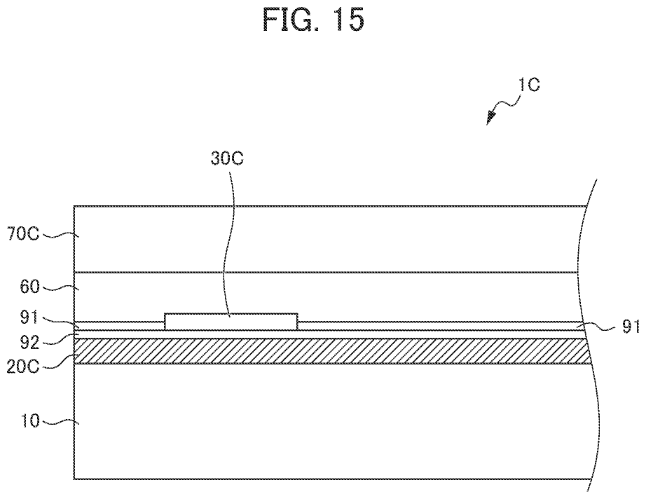

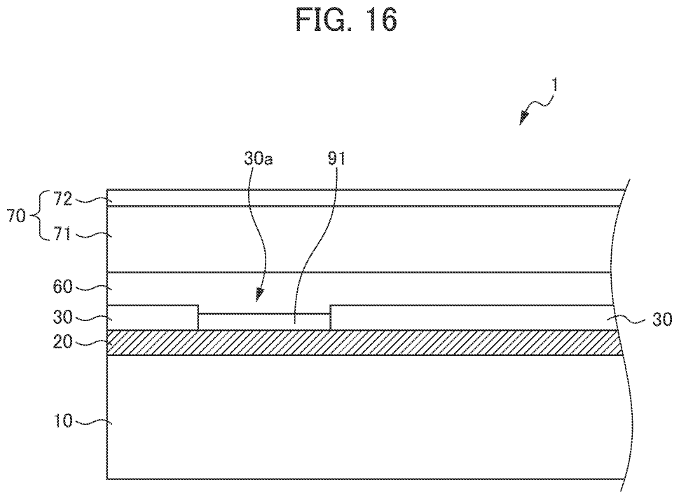

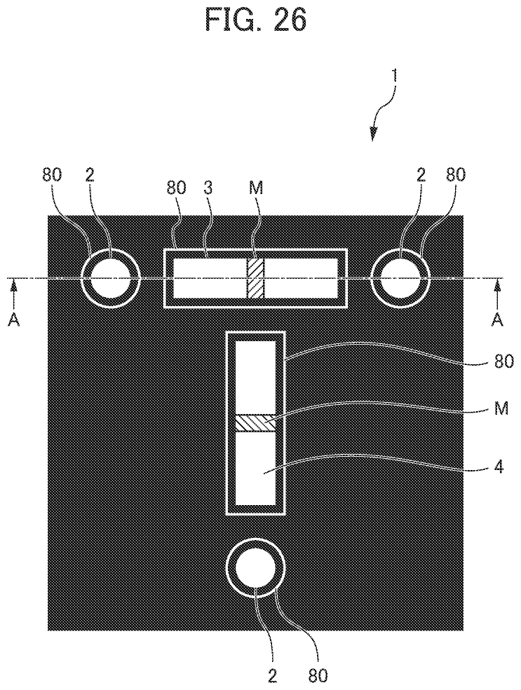

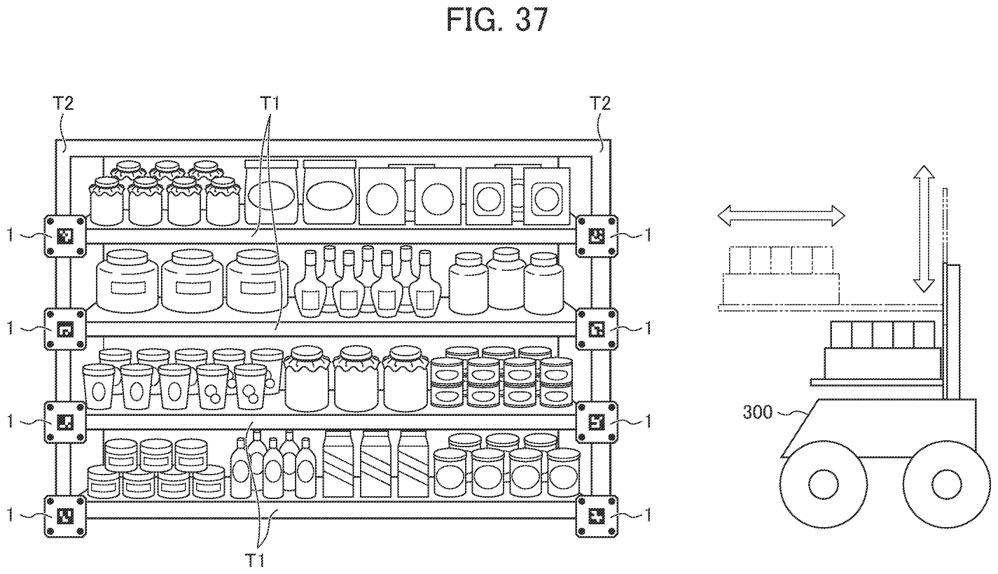

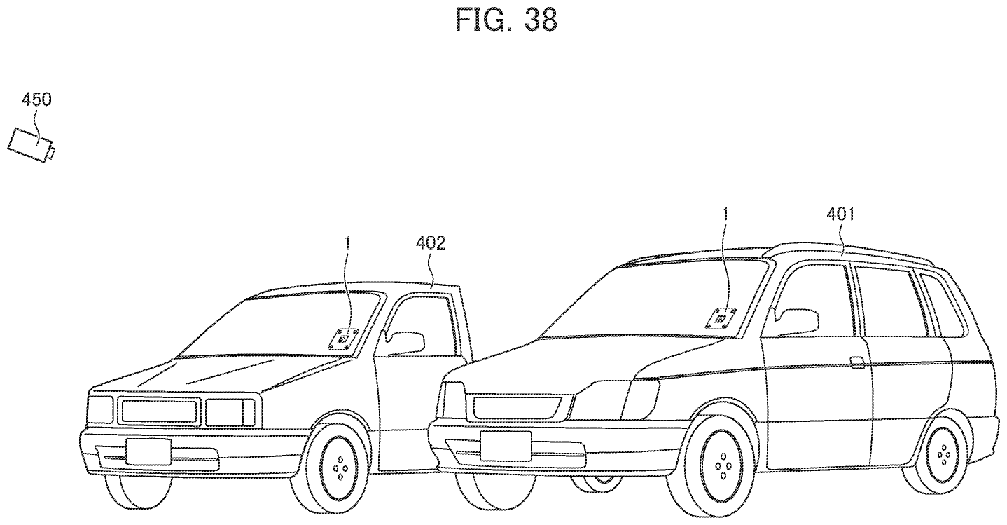

It may be possible to adopt various modifications without being limited to the above-described embodiments, and these modifications and alterations are also within the scope of the present invention.
(1) The first to third embodiments have been described by presenting the example in which the marker is configured so that the marks 2 are black and the peripheries thereof are white. Not limited to this example, for example, the marks 2 may be white and the peripheries thereof may be black. More specifically, for example, in the first embodiment, the first layer 20 may be white, and the second layer 30 on the observation side may be black. FIGS. 12 and 13 are diagrams showing a modified form in which the first layer 20 is white and the second layer 30 is black in the first embodiment. As shown in FIG. 13, the first layer 20 of the first embodiment is made white and the second layer 30 on the observation side is made black, whereby the marks 2 are white like the marker 1 shown FIG. 12, and the peripheries thereof are black. Further, for example, in the third embodiment, the first layer 20C may be black, and the second layer 30C on the observation side may be white. FIGS. 14 and 15 are diagrams showing a modified form in which the first layer 20C is black and the second layer 30C is white in the third embodiment. As shown in FIG. 15, the first layer 20C of the third embodiment is made black and the second layer 30 on the observation side is made white, whereby the marks 2 are white like the marker 1C shown in FIG. 14, and the peripheries thereof are black.
(2) The first to third embodiments have been described by presenting the example in which the marks 2 are represented with two colors of black and white. Not limited to this example, the embodiments may be configured so that the marker may be configured by combining other colors such as blue and yellow. Further, by adding a third layer to be observed in a third color, the embodiments may be configured so that a larger number of layers, which are observed in three or more colors, are laminated. Further, the difference in color in the present invention is not limited to the difference in color expressed by the combination of RGB, but can also include a difference caused by multi-gradation expression of a single color.
(3) The first to third embodiments have been described by presenting the example in which the marks 2 are enabled to be observed under visible light. Not limited to this example, the embodiments may be configured so that the marks 2 are detected by using light in a specific wavelength region such as an infrared ray region (near-infrared ray wavelength region of 780 nm or more). More specifically, the embodiments may be configured, for example, so that the marks 2 are observable in the near-infrared ray region but not observable or inconspicuous in a white light (visible light) region. If the marks 2 are formed of a near-infrared ray absorbing material, the marks 2 can be identified only by an element which receives near-infrared rays when the marks 2 are irradiated with near-infrared rays, but the marks 2 cannot be identified by human's eye. Known materials such as ITO, ATO, cyanine compound, phthalocyanine compound, di-thiol metal complex, naphthoquinone compound, diimmonium compound, and azo compound may be usable for the near-infrared ray absorbing material. As a result, it is possible to use the marker 1 (1B) for applications where it is desired to make the marker 1 (1B) inconspicuous. In such a case, it is desirable that the contrast value between the first color of the first layer 20 and the second color of the second layer 30 is equal to or more than 0.26 under observation using light in a specific wavelength region, whereas the contrast value between the first color and the second color is equal to or less than 1.0 under visible light. This makes it possible to make the marker inconspicuous under visible light and implement at the same time highly accurate position detection with light in a specific wavelength region.
(4) In the first to third embodiments, the configuration in which the protective layer 70 is stuck via the adhesive layer 60 is illustrated. Not limited to this example, the embodiments may be configured, for example, so that the protective layer is directly laminated on the second layer 30, or the protective layer may be omitted depending on the usage environment.
(5) The first to third embodiments have been described by presenting the example in which the masks M are used in the second exposure step in which a mark pattern is exposed to the second layer 30. Not limited to this example, for example, exposure of a mark pattern may be performed by a direct drawing method using a laser beam.
(6) The first to third embodiments have been described by presenting the example in which the first layer 20 is observable as a mark having an independent shape. Not limited to this example, for example, the embodiments may be configured so that the second layer 30 is observable as a mark having an independent shape. In connection with this, the resist material forming the second layer 30 may be a positive type or a negative type.
(7) In the first to third embodiments, a layer for improving adhesion, a layer for improving surface nature, a layer for diffusing light to provide antiglare, or the like may be inserted on an as-needed basis between layers, onto the outermost surface, or the like.
(8) The third embodiment has been described by presenting the example in which the flattening layer 91 is provided. Such a flattening layer may be provided in the first embodiment. FIG. 16 is a cross-sectional view showing a modified form in which the flattening layer 91 is provided in the opening portion 30a of the second layer 30 of the first embodiment. It is possible to prevent occurrence of voids by providing the flattening layer 91 in the opening portion 30a of the second layer 30 as shown in FIG. 16. Further, in the form of FIG. 16 and the third embodiment, an example in which the height of the flattening layer 91 is lower than those of the second layers 30 and 30C is shown. However, the flattening layer 91 may be slightly higher than those of the second layers 30 and 30C, more desirably the same height as the second layers 30, 30C.
(9) The fourth embodiment has been described by presenting the example in which the first layer 20 is black and the second layer 30 is white. Not limited to this example, the embodiment may be configured, for example, so that the first layer 20 is white and the second layer 30 is black, or may be configured not only by combining black and white, but also by combining other colors such as blue and yellow.
(10) The fourth embodiment has been described by presenting the example in which the black portion of the mark 2 and the first pattern 23 are formed by the first layer 20. Not limited to this example, for example, the mark 2 and the first pattern 23 may be provided on different layers.
(11) In the fourth embodiment, the configuration in which the protective layer 70 is stuck by the adhesive layer 60 is illustrated. Not limited to this example, the embodiments may be configured, for example, so that the protective layer is directly laminated on the second layer 30, or the protective layer may be omitted depending on the usage environment.
(12) The fourth embodiment has been described by presenting the example in which the moire display region 3 and the moire display region 4 are arranged so that the longitudinal directions thereof are orthogonal to each other. Not limited to this example, for example, a moire display region may be further added. In this case, the longitudinal direction of the added moire display region may be arranged in a direction which intersects the moire display region 3 and the moire display region 4 at an angle of 45 degrees or the like. With such a configuration, the accuracy of position detection can be further improved.
(13) In the fifth embodiment, the light diffusion layer has been described by presenting the example in which the sheet-like member is stuck. Not limited to this example, for example, a light diffusion layer may be configured by coating a resin or the like forming the light diffusion layer.
(14) The fifth embodiment has been described by presenting the example in which the light diffusion layer has micro asperities on the surface. Not limited to this example, for example, the light diffusion layer may be configured so as to have light-diffusing particles therein, or may be configured so as to have both micro asperities on the surface thereof and the light-diffusing particles therein.
(15) The fifth embodiment has been described by presenting the example in which the light diffusion layer is partially provided in an island-like shape. Not limited to this example, for example, the light diffusion layer may be provided on the entire surface of the marker.
(16) The fifth embodiment has been described by presenting the example in which the first layer 20 is black and the second layer 30 is white. Not limited to this example, for example, as shown in FIG. 26, the first layer 20 may be made white, the second layer 30 may be made black, or the fifth embodiment may be configured not only by combining black and white, but also by combining other colors such as blue and yellow. Further, by adding a third layer to be observed in a third color, the embodiments may be configured so that a larger number of layers, which are observed in three or more colors, are laminated. Further, the difference in color in the present invention is not limited to the difference in color expressed by the combination of RGB, but can also include a difference caused by multi-gradation expression of a single color.
(17) Each embodiment has been described by presenting the example in which both the first layer 20 and the second layer 30 are configured by using a resist material. Not limited to this example, for example, the first layer 20 and the second layer 30 may be configured by using a method of laminating a thermosetting resin on a necessary portion by an inkjet method or the like. Even in such a case, the linear expansion coefficient of the base material layer 10 is set to 10×10⁻⁶/° C. or less, whereby it is possible to secure sufficient accuracy depending on the application.
(18) The sixth embodiment has been described by presenting the example in which the measuring system of the present invention is applied to control of the forklift 200. Not limited to this example, the measuring system of the present invention can be applied to various fields. For example, the markers 1 may be arranged respectively at locations indoors, and may be applied to movement control of various transporters, robots and the like moving indoors. Further, cameras may be arranged respectively at locations indoors, markers may be arranged on various transporters, robots and the like moving indoors, and the present invention may be applied to movement control of the various transporters, robots and the like moving indoors. Further, this is not limited to indoor cases, and may be applied to movement control of drones and the like operating outdoors. Moreover, movement control is not necessarily performed, and this may be used for various types of measurement at construction sites, infrastructures, such as dams and bridges.
(19) The sixth embodiment has been described by presenting the example in which the measuring system of the present invention is applied to control of the forklift 200. Not limited to this example, the embodiment may be configured so that no controller is provided, and only a measurement result is obtained.
(20) The seventh embodiment has been described by presenting the example in which the measurement of the position and posture using the marks 2 (first calculation process), and the measurement of the position and posture using the figure (identification mark 5) (second calculation process) are performed in parallel. Not limited to this example, for example, in a case of an application where a time lag of switching calculation causes no problem, a form may be adopted where only the first calculation process is continuously performed, the second calculation process is not usually performed, and the processing is switched to the second calculation process only when the first calculation process cannot be performed.
(21) The seventh embodiment has been described by presenting the example in which the marker 1 is attached to the pallet P and used. Not limited to this example, for example, the marker 1 may be attached to a shelf on which goods are displayed and used. FIG. 37 is a diagram showing a first modified form of a utilization form of the marker 1 of the seventh embodiment. In the example shown in FIG. 37, markers 1 are respectively attached to intersecting positions (intersections) between shelf boards T1 of a shelf T and columns T2 of the shelf T. All ArUco markers as identification marks 5 provided for the markers 1 are respectively assigned different IDs. In this case, the camera, the calculator, and the controller are provided for an automatic transporter (robot) 300. The automatic transporter 300 can accurately grasp the intersecting positions (intersections) with the columns T2 of the shelf T by photographing the markers 1 and measuring the positions of the markers 1. Further, based on information obtained from the identification mark 5, the shelf board can be identified, the automatic transporter 300 can be automatically controlled to move to a proper position, and assortment, replacement, picking-up or the like of goods placed on the shelf T can be performed by automatic operation. For example, this configuration can be applied to merchandise shelves in stores, and also applied to shelves and the like in distribution warehouses, storehouses in factories, etc.
(22) The seventh embodiment has been described by presenting the example in which the marker 1 is attached to the pallet P and used. Not limited to this example, for example, the marker 1 may be attached to a front windshield or the like of an automobile, and used. FIG. 38 is a diagram showing a second modified form of a utilization form of the marker 1 of the seventh embodiment. FIG. 38 shows a situation where automobiles 401 and 402 are parked in a parking lot. In the example shown in FIG. 38, an identification mark 5 of a marker 1 attached to the front windshield of the automobile 401 and an identification mark 5 of a marker 1 attached to the front windshield of the automobile 402 respectively have IDs different from each other.

In the parking lot, a camera (imager) 450 is arranged, which photographs automobiles parked in the parking lot and is connected to a calculator, which is not shown. The IDs of the identification marks 5 of the markers 1 are associated with the external shapes, weights, registration numbers, owners, and the like of the respective automobiles as data. Therefore, based on a result photographed by the camera 450, payment of fees for the parking lot can be automated. Further, by measuring the position using the marker 1, it can be accurately grasped which automobile is parked at which position. Accordingly, in case of parking at a wrong position, a notification about this can be issued, and a staff member can be prompted to address this. In a case of an automobile, it is assumed that the front windshield becomes dirty with fallen leaves, dirt or the like. Even in such a case, by performing both the first calculation process and the second calculation process, a situation incapable of measuring the position can be avoided. Unlike the registration number of an automobile, ArUco that is the identification mark 5 cannot be easily read only at a glance by ordinary people and accordingly, it can contribute to privacy protection. A system that reads a registration plate and uses it for fee payment has been in practical use. However, with the registration plate, the position and posture cannot be accurately measured. On the other hand, use of the marker 1 makes it possible to accurately grasp the position of the automobile in the entire parking lot.

Although the respective embodiments and modified forms can be used in combination as appropriate, detailed description thereon will be omitted. Further, the present invention is not limited to the respective embodiments described above.

### EXPLANATION OF REFERENCE NUMERALS

1, 1B, 1C: Marker
2: Mark
3, 4: Moire display region
5: Identification mark
10: Base material layer
20, 20C: First layer
21: First display line
22: First non-display region
23: First pattern
30, 30C: Second layer
30a: Opening portion
31: Opening portion
32: Opening portion
40: Third layer
41: Second display line
42: Second non-display region
43: Second pattern
50: Reflective layer
60: Adhesive layer
70: Protective layer
71: Resin base material layer
72: Surface layer
80: Light diffusion layer
81: Resin base material layer
82: Surface layer
91: Flattening layer
92: Intermediate layer
100: Marker multi-imposition body
200: Forklift
201: Camera (imager)
202: Calculator
203: Controller
300: Automatic transporter
401, 402: Automobile
450: Camera (imager)
500: Measuring system

1. A measuring system comprising:
a marker;
an imager that photographs the marker; and
a calculator that calculates at least one selected from a relative positional relationship between the imager and the marker, a dimension of an object or a distance between designated positions in a vicinity of the marker, a distance between a plurality of markers arranged, and a posture of the marker, using an image of the marker photographed by the imager;
the marker including:
a base material layer;
a first layer that is laminated on an observation side of the base material layer and observed in a first color; and
a second layer that is partially laminated on an observation side of the first layer and observed in a second color different from the first color, the second layer partially concealing the first layer, wherein
the first layer is observable in a region where the second layer is not laminated, and
the second layer includes a resist material.

2. The measuring system according to claim 1,
wherein the first layer includes a resist material.

3. (canceled)

4. The measuring system according to claim 1,
wherein the base material layer includes glass.

5. The measuring system according to claim 1,
wherein either the first layer or the second layer is observable as a mark having an independent shape, and the mark includes three or more marks which are arranged to be spaced from one another.

6. The measuring system according to claim 5,
wherein a figure for identification is arranged, and the calculator identifies the marker with reference to the figure.

7. The measuring system according to claim 6,
wherein the calculator performs:
a first calculation process of calculating at least one selected from a relative positional relationship between the imager and the marker, a dimension of an object or a distance between designated positions in a vicinity of the marker, a distance between a plurality of markers arranged, and a posture of the marker, based on images of the marks included in the image of the marker; and
a second calculation process of calculating at least one selected from a relative positional relationship between the imager and the marker, a dimension of an object or a distance between designated positions in the vicinity of the marker, a distance between a plurality of markers arranged, and a posture of the marker, based on an image of the figure for identification included in the image of the marker.

8. The measuring system according to claim 7,
wherein the calculator outputs:
a calculation result by the first calculation process if calculation is performable properly by the first calculation process; and
a calculation result by the second calculation process if calculation is not performable properly by the first calculation process.

9. The measuring system according to claim 8,
wherein the calculator performs the first calculation process and the second calculation process in parallel.

10. The measuring system according to claim 1, further comprising:
a controller that performs control based on a calculation result of the calculator.

11. A measuring method of the measuring system according to claim 1, the method comprising:
a step of the imager photographing the marker; and
a step of the calculator calculating at least one selected from a relative positional relationship between the imager and the marker, a dimension of an object or a distance between designated positions in a vicinity of the marker, a distance between a plurality of markers arranged, and a posture of the marker, using an image of the marker photographed by the imager.

12. A computer-readable storage medium storing a program of the measuring system according to claim 1, the program causing a computer to execute a process, comprising:
a step of the imager photographing the marker; and
a step of the calculator calculating at least one selected from a relative positional relationship between the imager and the marker, a dimension of an object or a distance between designated positions in a vicinity of the marker, a distance between a plurality of markers arranged, and a posture of the marker, using an image of the marker photographed by the imager.

13. A measuring system comprising:
a marker;
an imager that photographs the marker; and
a calculator that calculates at least one selected from a relative positional relationship between the imager and the marker, a dimension of an object or a distance between designated positions in a vicinity of the marker, a distance between a plurality of markers arranged, and a posture of the marker, using an image of the marker photographed by the imager;
the marker including:
a base material layer;
a first layer that is laminated on an observation side and an entire surface of the base material layer and observed in a first color; and
a second layer that is partially laminated on an observation side of the first layer and observed in a second color different from the first color, the second layer partially concealing the first layer, wherein
the first layer is observable in a region where the second layer is not laminated, and
the base material layer has a linear expansion coefficient of 10×10⁻⁶/° C. or less.

14. The measuring system according to claim 13,
wherein the base material layer includes glass.

15. The measuring system according to claim 13,
wherein either the first layer or the second layer is observable as a mark having an independent shape, and the mark includes three or more marks which are arranged to be spaced from one another.

16. The measuring system according to claim 15,
wherein a figure for identification is arranged, and the calculator identifies the marker with reference to the figure.

17. The measuring system according to claim 16,
wherein the calculator performs:
a first calculation process of calculating at least one selected from a relative positional relationship between the imager and the marker, a dimension of an object or a distance between designated positions in a vicinity of the marker, a distance between a plurality of markers arranged, and a posture of the marker, based on images of the marks included in the image of the marker; and
a second calculation process of calculating at least one selected from a relative positional relationship between the imager and the marker, a dimension of an object or a distance between designated positions in the vicinity of the marker, a distance between a plurality of markers arranged, and a posture of the marker, based on an image of the figure for identification included in the image of the marker.

18. The measuring system according to claim 17,
wherein the calculator outputs:
a calculation result by the first calculation process if calculation is performable properly by the first calculation process; and
a calculation result by the second calculation process if calculation is not performable properly by the first calculation process.

19. The measuring system according to claim 18,
wherein the calculator performs the first calculation process and the second calculation process in parallel.

20. The measuring system according to claim 13, further comprising:
a controller that performs control based on a calculation result of the calculator.

21. A measuring method of the measuring system according to claim 13, the method comprising:
a step of the imager photographing the marker; and
a step of the calculator calculating at least one selected from a relative positional relationship between the imager and the marker, a dimension of an object or a distance between designated positions in a vicinity of the marker, a distance between a plurality of markers arranged, and a posture of the marker, using an image of the marker photographed by the imager.

22. A computer-readable storage medium storing a program of the measuring system according to claim 13, the program causing a computer to execute a process, comprising:
a step of the imager photographing the marker; and
a step of the calculator calculating at least one selected from a relative positional relationship between the imager and the marker, a dimension of an object or a distance between designated positions in a vicinity of the marker, a distance between a plurality of markers arranged, and a posture of the marker, using an image of the marker photographed by the imager.
